(19) United States
(12) Patent Application Publication
(10) Pub. No.: US 2021/0055448 A1
(43) Pub. Date: Feb. 25, 2021

(54) ENHANCED TWO DIMENSIONAL INVERSION

(71) Applicant: SCHLUMBERGER TECHNOLOGY CORPORATION, Sugar Land, TX (US)

(72) Inventors: Michael Thiel, Cambridge, MA (US); Dzevat Omeragic, Lexington, MA (US)

(21) Appl. No.: 16/079,125

(22) PCT Filed: Feb. 23, 2017
(86) PCT No.: PCT/US2017/018993

§ 371 Date: Aug. 23, 2018

Related U.S. Application Data
(60) Provisional application No. 62/298,732, filed on Feb. 23, 2016.

(30) Foreign Application Priority Data
Oct. 19, 2016 (US) PCT/US2016/057564

(51) Int. Cl. G01V 3/38; G01V 3/18; E21B 47/13

(52) U.S. Cl. CPC G01V 3/38; E21B 47/13; G01V 3/18

(57) ABSTRACT

A method for characterizing a subterranean formation, the method comprising: performing electromagnetic logging measurements along a portion of a borehole traversing the subterranean formation using an electromagnetic logging tool to obtain electromagnetic data; determining one or more initial approximations for one or more electromagnetic properties associated with a two dimensional imaging plane modeling the subterranean formation; determining one or more initial approximations for a relative orientation between the two dimensional imaging plane and an orientation of a trajectory along the portion of the borehole; and performing a first inversion using (i) the one or more initial approximations of the one or more electromagnetic properties, (ii) the one or more initial approximations for the relative orientation between the two dimensional imaging plane and the orientation of the trajectory, and (iii) the electromagnetic data to estimate an orientation of the two dimensional imaging plane relative to the orientation of the trajectory.

### RELATED APPLICATIONS

This application claims the benefit of U.S. Provisional Application Ser. No. 62/298,732 entitled “Two Dimensional Pixel-Based Inversion” filed Feb. 23, 2016, which is incorporated in its entirety by reference herein. This application is also related to PCT Application No. PCT/US2016/057564 entitled “Two Dimensional Pixel-Based Inversion” filed on Oct. 19, 2016, which is incorporated in its entirety by reference herein.

### BACKGROUND

Logging tools have long been used in boreholes to make formation evaluation measurements to infer properties of a formation surrounding a borehole and properties of fluids in the formation. Common logging tools include resistivity (electromagnetic) tools, nuclear tools, acoustic tools, and nuclear magnetic resonance (NMR) tools, though various other types of tools for evaluating formation properties are also available.

Early logging tools were run into a borehole on a wireline cable after the borehole had been drilled. Modern versions of such wireline tools are still used extensively. However, as the demand for information while drilling a borehole has continued to increase, measurement-while-drilling (MWD) tools and logging-while-drilling (LWD) tools have since been developed. MWD tools often provide drilling parameter information such as weight on the bit, torque, temperature, pressure, direction, and inclination. LWD tools often provide formation evaluation measurements such as resistivity, porosity, NMR, and so forth. MWD and LWD tools often have characteristics common to wireline tools (e.g., transmitting and receiving antennas, sensors, etc.), however MWD and LWD tools are designed and constructed to operate and endure in the harsh environment of drilling.

The above descriptions and examples are not admitted to be prior art by virtue of their inclusion in this section.

### SUMMARY

Illustrative embodiments of the present disclosure are directed to a method for characterizing a subterranean formation. The method includes performing electromagnetic logging measurements along a portion of a borehole traversing the subterranean formation using an electromagnetic logging tool to obtain electromagnetic data. The method also includes determining one or more initial approximations for one or more electromagnetic properties associated with a two dimensional imaging plane modeling the subterranean formation. The method further includes determining one or more initial approximations for a relative orientation between the two dimensional imaging plane and an orientation of a trajectory along the portion of the borehole. An inversion is performed using (i) the one or more initial approximations of the one or more electromagnetic properties, (ii) the one or more initial approximations for the relative orientation between the two dimensional imaging plane and the orientation of the trajectory, and (iii) the electromagnetic data to estimate an orientation of the two dimensional imaging plane relative to the orientation of the trajectory.

Various embodiments of the present disclosure are also directed to another method for characterizing a subterranean formation. The method includes performing electromagnetic logging measurements along a portion of a borehole traversing the subterranean formation using an electromagnetic logging tool to obtain electromagnetic data. The method also includes determining one or more electromagnetic properties by performing a one dimensional inversion using the electromagnetic data. The method further includes creating a two dimensional formation model in a reference trajectory plane by mapping the one or more electromagnetic properties onto a two dimensional grid. A first inversion is performed using at least some information associated with the two dimensional formation model to estimate an orientation of a two dimensional imaging plane associated with the two dimensional formation model relative to the reference trajectory plane. A second inversion is performed using at least some information associated with the two dimensional formation model to estimate electromagnetic property values for the two dimensional imaging plane.

Illustrative embodiments of the present disclosure are further directed to a system for characterizing a subterranean formation. The system includes an electromagnetic logging tool configured to perform electromagnetic logging measurements along a portion of a borehole traversing the subterranean formation to obtain electromagnetic data. The system also includes a processing system that (i) determines one or more initial approximations for one or more electromagnetic properties associated with a two dimensional imaging plane modeling the subterranean formation; (ii) determines one or more initial approximations for a relative orientation between the two dimensional imaging plane and an orientation of a trajectory along the portion of the borehole; and (iii) performs a first inversion using (a) the one or more initial approximations of the one or more electromagnetic properties, (b) the one or more initial approximations for the relative orientation between the two dimensional imaging plane and the orientation of the trajectory, and (c) the electromagnetic data to estimate an orientation of the two dimensional imaging plane relative to the orientation of the trajectory.

This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example wellsite system within which various embodiments of the present disclosure can be employed;

FIG. 2 illustrates an example processing system which can be used in conjunction with various embodiments of the present disclosure;

FIG. 3 illustrates an example logging tool that can be used in conjunction with various embodiments of the present disclosure;

FIG. 4 illustrates an example schematic visualization of a one dimensional formation representation in accordance with various embodiments of the present disclosure;

FIG. 5 illustrates an example two dimensional pixel grid in accordance with various embodiments of the present disclosure;

FIG. 6 illustrates an example 2D formation model in accordance with various embodiments of the present disclosure;

FIG. 7 illustrates an example visualization of Occam's method to estimate gradient penalization constants in accordance with various embodiments of the present disclosure;

FIG. 8 illustrates an example 2D pixel inversion domain discretization associated with various embodiments of the present disclosure;

FIG. 9 illustrates an example coordinate system of an imaging plane in accordance with various embodiments of the present disclosure;

FIG. 10 illustrates an example coordinate system used in 2.5D forward modeling relative to a trajectory X and TVD for a 2D inversion after rotation of the trajectory with an azimuth angle α and for a relative polar angle β=0 in accordance with various embodiments of the present disclosure;

FIG. 11 illustrates an example update of an extension of a two dimensional structure in accordance with various embodiments of the present disclosure;

FIG. 12 illustrates an example two dimensional pixel inversion result in accordance with various embodiments of the present disclosure;

FIG. 13 illustrates an example non-uniform inversion grid for high relative angle inversion in accordance with various embodiments of the present disclosure;

FIG. 14 illustrates an example flow diagram associated with a shallow to deep inversion workflow in accordance with various embodiments of the present disclosure;

FIG. 15 illustrates an example 2D formation model in accordance with various embodiments of the present disclosure;

FIG. 16 illustrates an example final inversion result in accordance with various embodiments of the present disclosure;

FIG. 17 illustrates an example scatter plot in accordance with various embodiments of the present disclosure;

FIG. 18 illustrates the means and standard deviations of relative data reconstruction errors associated with multiple measurements in accordance with various embodiments of the present disclosure;

FIG. 19 illustrates an example method according to various embodiments of the present disclosure; and

FIG. 20 illustrates an example method according to various embodiments of the present disclosure.

### DETAILED DESCRIPTION

In the following description, numerous details are set forth to provide an understanding of some embodiments of the present disclosure. However, it will be understood by those of ordinary skill in the art that the systems and/or methodologies disclosed herein may be practiced without these details and that numerous variations or modifications from the described embodiments may be possible. Additionally, it should be understood that references to “one implementation”, “one embodiment”, “an implementation”, “an embodiment”, etc., within the present disclosure are not to be interpreted as excluding the existence of additional embodiments and implementations that also incorporate some or all of the recited features.

Moreover, some examples discussed herein may involve technologies associated with the oilfield services industry. It will be understood however that the techniques of enhanced two dimensional inversion may also be useful in a wide range of other industries outside the oilfield services sector, including for example, mining, geological surveying, etc.

It will also be understood that even though some embodiments described herein may specify pixel inversion, any other forms of inversion known in the art may also be used. For example, model-based inversion where formation property boundaries are invertible can also be used.

The enhanced two-dimensional inversion method described herein can be used to determine (i) a two dimensional reservoir electromagnetic property distribution in an imaging plane (including for example one or more electromagnetic property distributions) and (ii) angles defining orientation of the imaging plane with respect to a borehole trajectory. The 2D imaging planes and the associated angles can be used to create three dimensional (3D) models of a subsurface formation. It will be understood that electromagnetic property distributions can include, for example, resistivity distributions, resistivity anisotropy distributions, conductivity distributions, conductivity anisotropy distributions, dielectric permittivity distributions, dielectric permittivity anisotropy distributions, etc. In one possible implementation, the resistivity and resistivity anisotropy distributions can be described with the horizontal resistivity (Rₕ) and the vertical resistivity (Rᵥ) distributions. Similarly, it will be understood that electromagnetic properties can include, for example, resistivity, resistivity anisotropy, conductivity, conductivity anisotropy, dielectric permittivity, dielectric permittivity anisotropy, etc. The dielectric permittivity and dielectric permittivity anisotropy distributions can be described with the horizontal dielectric permittivity (Eh) and the vertical dielectric permittivity (εᵥ) distributions.

As also described herein, various techniques and technologies associated with the two dimensional inversion described herein can be used to interpret electromagnetic measurements such as, for example, by matching downhole tool measurements using a two dimensional (2D) formation model with arbitrary angles and/or an azimuth with respect to a trajectory of the tool.

As also described herein, in various techniques and technologies associated with enhanced two dimensional inversion, 3D measurement channels used in an inversion can be used for improved azimuthal imaging quality and to define a relative orientation of a formation invariant direction with respect to a borehole.

As also described herein, in various techniques and technologies associated with enhanced two dimensional inversion, various inversion strategies can be pursued using a set of measurements (such as for example, directional resistivity measurements, etc.). For instance, in one possible implementation, 2D inversion can be pursued with a 2D imaging plane at a low relative azimuth with respect to a trajectory of a downhole logging tool. In such an implementation, results of one or more 1D inversions can be used as an initial approximation, and the azimuth angle of the 2D imaging plane can be estimated with respect to the tool reference together with the 2D reservoir property distribution (of, for example, resistivity and resistivity anisotropy information, etc.) in the 2D imaging plane. In another possible implementation, 2D inversion can be pursued with a 2D imaging plane at a high azimuth with respect to the trajectory of the downhole logging tool. In such an implementation, 1D inversion results may not be usable, so the inversion can start with the 2D imaging plane assuming an approximately 90° azimuth to the borehole trajectory. In one possible aspect, relative angles of the 2D imaging plane together with the reservoir property distribution in the 2D imaging plane can be determined with respect to the trajectory of the downhole logging tool. In one possible aspect, the two relative angles can determine the invariant direction of the formation

The concepts and techniques of the enhanced two dimensional inversion described herein can be used for a variety of applications, including, for example, well placement and reservoir characterization. Further the concepts and techniques of the enhanced two dimensional inversion can be employed while drilling and/or after drilling is completed, or through use of wireline measurements.

### Example Wellsite System

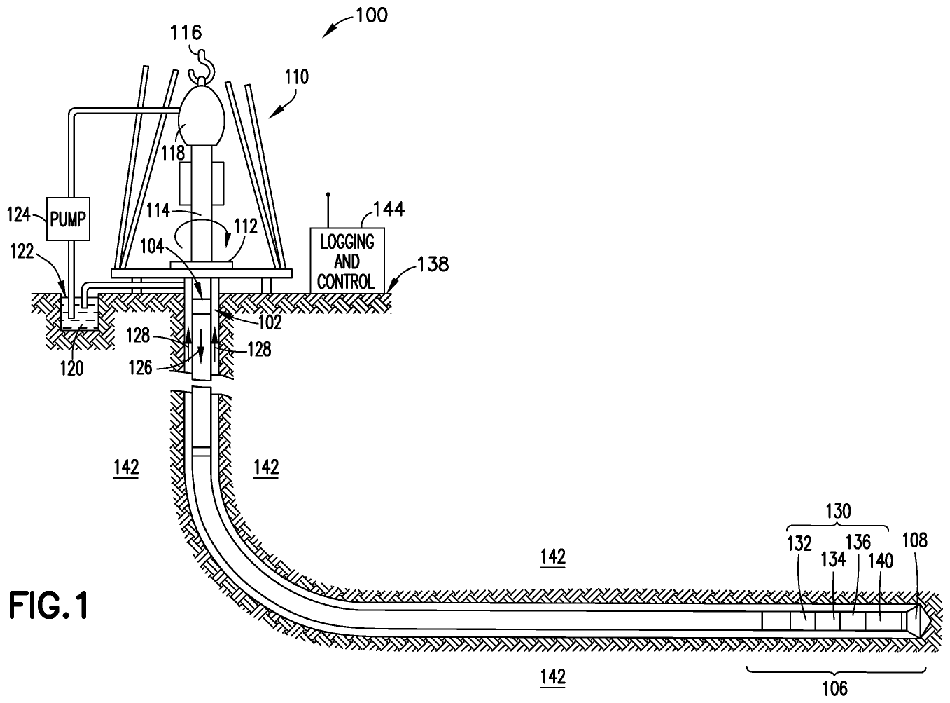

FIG. 1 illustrates a wellsite system 100 with which embodiments of the two dimensional inversion method described herein can be employed. Wellsite system 100 can be an onshore wellsite or offshore wellsite. In this case, the wellsite system 100 is located at an onshore wellsite. In this example wellsite system, a borehole 102 is formed in a subsurface formation by rotary drilling in a manner that is well known. Embodiments of two dimensional inversion can also be employed in association with wellsite systems to perform directional drilling.

The wellsite system 100 includes a drill string 104 that can be suspended within borehole 102. The drill string 104 includes a bottom-hole assembly 106 with a drill bit 108 at its lower end. The system 100 can include a platform and derrick assembly 110 positioned over the borehole 102. The assembly 110 can include a rotary table 112, kelly 114, hook 116 and rotary swivel 118. The drill string 104 can be rotated by the rotary table 112, energized by means not shown, which engages kelly 114 at an upper end of drill string 104. Drill string 104 can be suspended from hook 116, attached to a traveling block (also not shown), through kelly 114 and a rotary swivel 118 which can permit rotation of drill string 104 relative to hook 116. As is well known, a top drive system can also be used.

In the example of this embodiment, drilling fluid or mud 120 is stored in a pit 122 formed at the wellsite. A pump 124 can deliver drilling fluid 120 to an interior of drill string 104 via a port in swivel 118, causing drilling fluid 120 to flow downwardly through drill string 104 as indicated by directional arrow 126. Drilling fluid 120 can exit drill string 104 via ports in drill bit 108, and circulate upwardly through an annulus region between the outside of drill string 104 and wall of the borehole 102, as indicated by directional arrows 128. In this well-known manner, drilling fluid 120 can lubricate drill bit 108 and carry formation cuttings up to the surface as drilling fluid 120 is returned to pit 122 for recirculation.

Bottom-hole assembly 106 of the illustrated embodiment can include drill bit 108 as well as a variety of equipment 130, including a logging-while-drilling (LWD) module 132, a measuring-while-drilling (MWD) module 134, a roto-steerable system and motor.

In one possible implementation, LWD module 132 can be housed in a special type of drill collar, as is known in the art, and can include one or more of a plurality of known types of logging tools (e.g., an electromagnetic logging tool, a nuclear magnetic resonance (NMR) tool, and/or a sonic logging tool). It will also be understood that more than one LWD and/or MWD module can be employed (e.g., as represented at position 136). (References, throughout, to a module at position 132 can also mean a module at position 136 as well). LWD module 132 can include capabilities for measuring, processing, and storing information, as well as for communicating with surface equipment.

MWD module 134 can also be housed in a special type of drill collar, as is known in the art, and include one or more devices for measuring characteristics of the well environment, such as characteristics of the drill string and drill bit. MWD module 134 can further include an apparatus (not shown) for generating electrical power to the downhole system. This may include a mud turbine generator powered by the flow of drilling fluid 120, it being understood that other power and/or battery systems may be employed. MWD module 134 can include one or more of a variety of measuring devices known in the art (e.g., a weight-on-bit measuring device, a torque measuring device, a vibration measuring device, a shock measuring device, a stick slip measuring device, a direction measuring device, and an inclination measuring device).

MWD tools in MWD module 134, and LWD tools in LWD module 132 can include one or more characteristics common to wireline tools (e.g., transmitting and receiving antennas, sensors, etc.), with MWD and LWD tools being designed and constructed to endure and operate in the harsh environment of drilling.

Various systems and methods can be used to transmit information (data and/or commands) from equipment 130 to a surface 138 of the wellsite. In one implementation, information can be received by one or more sensors 140. The sensors 140 can be located in a variety of locations and can be chosen from any sensing and/or detecting technology known in the art, including those capable of measuring various types of radiation, electric or magnetic fields, including electrodes (such as stakes), magnetometers, coils, etc.

In one possible implementation, information from equipment 130, including LWD data and/or MWD data, can be utilized for a variety of purposes including steering drill bit 108 and any tools associated therewith, characterizing a formation 142 surrounding borehole 102, characterizing fluids within borehole 102, etc. For example, information from equipment 130 can be used to create one or more sub-images of various portions of borehole 102.

In one implementation a logging and control system 144 can be present. Logging and control system 144 can receive and process a variety of information from a variety of sources, including equipment 130. Logging and control system 144 can also control a variety of equipment, such as equipment 130 and drill bit 108.

Logging and control system 144 can also be used with a wide variety of oilfield applications, including logging while drilling, artificial lift, measuring while drilling, wireline, etc., and can include one or more processor-based computing systems. In the present context, a processor may include a microprocessor, programmable logic devices (PLDs), field-gate programmable arrays (FPGAs), application-specific integrated circuits (ASICs), system-on-a-chip processors (SoCs), or any other suitable integrated circuit capable of executing encoded instructions stored, for example, on tangible computer-readable media (e.g., read-only memory, random access memory, a hard drive, optical disk, flash memory, etc.). Such instructions may correspond to, for instance, workflows and the like for carrying out a drilling operation, algorithms and routines for processing data received at the surface from equipment 130, and so on.

Logging and control system 144 can be located at surface 138, below surface 138, proximate to borehole 102, remote from borehole 102, or any combination thereof. For example, in one possible implementation, information received by equipment 130 and/or sensors 140 can be processed by logging and control system 144 at one or more locations, including any configuration known in the art, such as in one or more handheld devices proximate and/or remote from wellsite 100, at a computer located at a remote command center, a computer located at wellsite 100, etc.

In one aspect, logging and control system 144 can be used to create images of borehole 102 and/or formation 142 from information received from equipment 130 and/or from various other tools, including wireline tools. In one possible implementation, logging and control system 144 can also perform various aspects of the two dimensional inversion method described herein to perform an inversion to obtain one or more desired formation parameters. Logging and control system 144 can also use information obtained from the two dimensional inversion to perform a variety of operations including, for example, steering drill bit 108 through formation 142, with or without the help of a user.

FIG. 1 shows an example of wellsite drilling system 100. However, embodiments of the two dimensional inversion method described herein are not limited to drilling systems. For example, various embodiments of the two dimensional inversion method can be implemented with wireline systems.

### Example Processing System

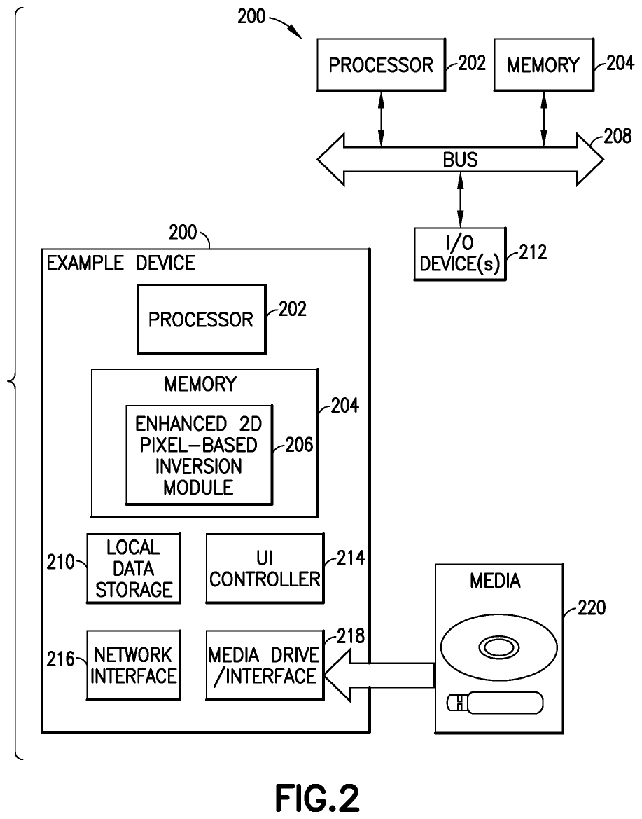

FIG. 2 illustrates an example processing system 200, with a processor 202 and memory 204 for hosting a two dimensional inversion module 206 configured to implement various embodiments of the two dimensional inversion as discussed in this disclosure. Memory 204 can also host one or more databases and can include one or more forms of volatile data storage media such as random access memory (RAM), and/or one or more forms of nonvolatile storage media (such as read-only memory (ROM), flash memory, and so forth).

Processing system 200 is one example of a computing system or programmable system, and is not intended to suggest any limitation as to scope of use or functionality of processing system 200 and/or its possible architectures. For example, processing system 200 can comprise one or more desktop computers, programmable logic controllers (PLCs), laptop computers, handheld devices, mainframe computers, high performance computing (HPC) clusters, clouds, etc., including any combination thereof.

Further, processing system 200 should not be interpreted as having any dependency relating to one or a combination of components illustrated in processing system 200. For example, processing system 200 may include one or more of a computer, such as a laptop computer, a desktop computer, a mainframe computer, etc., or any combination or accumulation thereof.

Processing system 200 can also include a bus 208 configured to allow various components and devices, such as processors 202, memory 204, and local data storage 210, among other components, to communicate with each other.

Bus 208 can include one or more of any of several types of bus structures, including a memory bus or memory controller, a peripheral bus, an accelerated graphics port, and a processor or local bus using any of a variety of bus architectures. Bus 208 can also include wired and/or wireless buses.

Local data storage 210 can include fixed media (e.g., RAM, ROM, a fixed hard drive, etc.) as well as removable media (e.g., a flash memory drive, a removable hard drive, optical disks, magnetic disks, and so forth).

One or more input/output (I/O) device(s) 212 may also communicate via a user interface (UI) controller 214, which may connect with I/O device(s) 212 either directly or through bus 208.

In one possible implementation, a network interface 216 may communicate outside of processing system 200 via a connected network, and in some implementations may communicate with hardware.

A media drive/interface 218 can accept removable tangible media 220, such as flash drives, optical disks, removable hard drives, software products, etc. In one possible implementation, logic, computing instructions, and/or software programs comprising elements of two dimensional inversion module 206 may reside on removable media 220 readable by media drive/interface 218.

In one possible embodiment, input/output device(s) 212 can allow a user to enter commands and information to processing system 200, and also allow information to be presented to the user and/or other components or devices. Examples of input device(s) 212 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various processes of two dimensional inversion module 206 may be described herein in the general context of software or program modules, or the module may be implemented in pure computing hardware. Software generally includes routines, programs, objects, components, data structures, and so forth that perform particular tasks or implement particular data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates non-transitory tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

In one possible implementation, processing system 200, or a plurality thereof, can be employed with the wellsite system 100. This can include, for example, in various equipment 130, in logging and control system 144, etc.

### Example Tools

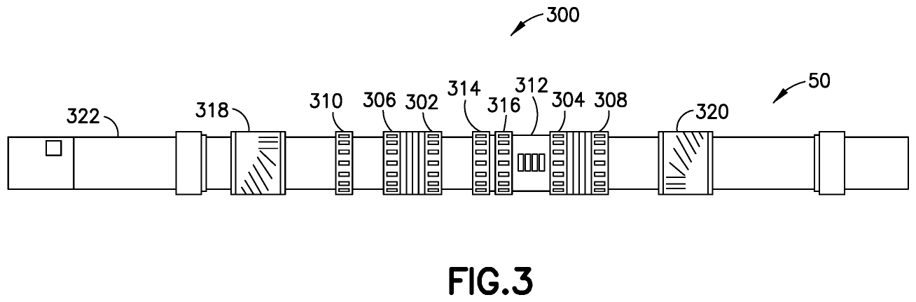

FIG. 3 illustrates an example electromagnetic logging tool 300 that can be used in conjunction with various embodiments of the two dimensional inversion method described herein. The electromagnetic logging tool 300 can be deployed in borehole 102, including high angle and/or horizontal wells (HA/HZ), vertical wells, deviated wells, etc. The electromagnetic logging tool can be deployed as part of an LWD module 132, as part of an MWD module, and/or as part of a wireline tool (e.g., a triaxial induction tool with one or more orthogonal sets of antennas such as the RtScanner™ of Schlumberger Technology Corporation). The electromagnetic logging tool 300 includes electromagnetic coupling components that can be used to determine characteristics of a formation 142.

In one possible implementation, electromagnetic logging tool 300 may be a multi-spacing directional electromagnetic propagation tool. Directional electromagnetic propagation tools are also know in the art as “directional resistivity tools” or “deep directional resistivity tool.” In one possible aspect, the electromagnetic logging tool 300 may be capable of making measurements at multiple frequencies, such as at 100 kHz, 400 kHz, 2 MHz, etc. As illustrated, the electromagnetic logging tool 300 includes multiple transmitters 302, 304, 306, 308, 310 and 312 and multiple receivers 314, 316, 318, and 320 spaced axially along a body 322 of logging tool 300. In the depicted example, electromagnetic logging tool 300 includes axial, transverse, and tilted antennas. Axial antennas can include dipole moments substantially parallel with a longitudinal axis of logging tool 300, such as, for example, as shown at transmitter 304. Axial antennas are commonly wound about the circumference of a logging tool such that the plane of the antenna is orthogonal to the tool axis. Axial antennas produce a radiation pattern that is equivalent to a dipole along the axis of the tool (by convention the z-direction). Electromagnetic measurements made by axially oriented antennas may be referred to as conventional or non-directional measurements.

A transverse antenna is one whose dipole moment is substantially perpendicular to the longitudinal axis of a logging tool, such as, for example, transmitter 312. A transverse antenna may include a saddle coil and generate a radiation pattern that is equivalent to a dipole that is perpendicular to the axis of the tool (by convention the x or y direction). A tilted antenna is one whose dipole moment is neither parallel nor perpendicular to the longitudinal axis of a logging tool, such as, for example, receivers 318 and 320. Tilted antennas generate a mixed mode radiation pattern (i.e., a radiation pattern in which the dipole moment is neither parallel nor perpendicular with the tool axis). Electromagnetic measurements made by transverse or tilted antennas may be referred to as directional measurements.

As illustrated in FIG. 3, five of the transmitter antennas 302, 304, 306, 308 and 310 are axial antennas spaced along the axis of logging tool 300. A sixth transmitter antenna (312) is a transverse antenna. First and second receivers (314 and 316) located axially between the transmitters are axial antennas and may be used to obtain conventional non-directional type propagation resistivity measurements. Third and fourth receivers (318 and 320) are tilted antennas located axially about the transmitters. Such a directional arrangement (including tilted and/or transverse antennas) produces a sensitivity on one azimuthal side of logging tool 300 that better enables bed boundaries and other features of the subterranean formations to be identified and located.

Accordingly, as the electromagnetic logging tool 300 in FIG. 3 provides both axial transmitters and axial receiver pairs as well as axial transmitter and tilted receiver pairs, the electromagnetic logging tool 300 is capable of making both directional and non-directional electromagnetic measurements. Further, the electromagnetic logging tool 300 illustrated in FIG. 3 can be capable of providing symmetrized and anti-symmetrized measurements (up and down measurements) with the same antenna spacings. As an example, in one particular embodiment, electromagnetic logging tool 300 may be capable of making measurements using transmitter-receiver pairs with spacings of, for example, 22, 34, 84, and 96 inches.

The electromagnetic logging tool 300 is not limited to the example provided in FIG. 3. The electromagnetic logging may include any configuration known in the art. For example, the electromagnetic logging tool 300 can have one or more transmitting antennas on a first modular sub and one or more receiver antennas on a second modular sub. The subs including the transmitting and receiving antennas may be distributed at different locations along drill string 104. As an illustrative example, in one possible embodiment, one sub (could be transmitter or receiver) may include multiple antennas having tilted dipole moments. The antennas, in one embodiment, may include three antennas with substantially equal angle tilts, but rotated 120 degrees apart azimuthally. In other embodiments, a given sub may include a set of multi-axial collocated antennas, such a tri-axial collocated antenna array having three antennas, each having dipole moments that are orthogonal with respect to the other two. In such modular tool embodiments, transmitter-receiver spacings of greater distances compared to those found on the logging tool 300 of FIG. 3 can be achieved. For example, in some embodiments, transmitter-receiver spacings of 10 feet or more, 30 feet or more, 60 feet or more, and even 100 feet or more may be achieved, providing for deep directional electromagnetic measurements.

### Example Methods

Illustrative embodiments of the 2D inversion method described herein can be used to process subsurface measurement data, such as electromagnetic data collected using electromagnetic logging tool 300, to determine various parameters of interest. The 2D inversion method described herein uses a process known as an “inversion”. In general, inversion processing includes making an initial estimate or model of the geometry and properties of the earth formations, such as formation 142, surrounding electromagnetic logging tool 300. The initial model parameters may be derived in various ways known in the art and an expected response expected to be measured by logging tool 300 can be calculated based on the initial model of formation 142 and/or borehole 102. This calculated response can then be compared to an actual response measured by logging tool 300. Differences between the calculated response and the actual response can then be used to adjust the parameters of the initial model to create an adjusted model of formation 142, which can then be used to calculate a second calculated response that might be expected to be measured by logging tool 300. The second calculated response can then be compared to the actual response measured by logging tool 300, and any differences between the second calculated response and the actual response can be used to again adjust the model. This process can be repeated until the differences between the calculated response and the actual response measured by logging tool 300 fall below a pre-selected threshold. In one possible implementation, inversion decreases and/or minimizes a cost function in terms of difference between the calculated response and the actual response measured by logging tool 300, sometimes referred as the error term, through adjusting the model of formation 142 and/or borehole 102, defined by geometry and various properties. By way of example, U.S. Pat. No. 6,594,584, issued on Jul. 15, 2003, and PCT Application WO 2015/134455, published on Sep. 11, 2015, describe some inversion techniques and are incorporated herein by reference in their entireties.

In one specific example, the 2D inversion method described herein can be used for geosteering applications. More specifically, the 2D inversion method can be performed by a logging and control system 104 as a drilling operation is performed. The 2D inversion method is used to determine a 2D formation model based upon electromagnetic data acquired by the electromagnetic tool as the drilling operation is performed. The 2D formation model is then used to make steering decisions, such as maintaining the drilling tool within a particular formation layer or avoiding boundaries, faults, and obstacles. The logging and control system 104 can send control signals to the drilling tool to steer the drill bit 108. In this manner, the 2D inversion method can be used to steer the drilling tool in real-time as the drilling operation is performed.

In one possible embodiment, some inversion techniques described herein can use anisotropy and/or anti-symmetrized measurements from induction and/or propagation measurements to estimate formation resistivity and resistivity anisotropy and formation dip at any inclination, independent of mud type. In accordance with some embodiments of enhanced two dimensional inversion, a minimally biased real-time interpretation approach based on inversion is disclosed which does not assume a number of layers, an assumption often present in some existing model-based inversion approaches. Instead of inverting for distance to boundary layer thicknesses, bed resistivities, and dip, some techniques invert for distribution of resistivities using predefined thin layers referred to as “pixels.” The boundary positions are inferred from changes in resistivities. In one possible aspect, inversion can be performed for anisotropic resistivity distribution and dip in a 1D inversion.

In one possible implementation, the pixel distribution can be based on measurement sensitivities, and the pixel size can be derived such that the contribution of each pixel to responses is nearly the same. As an illustrative example, in 1D inversions, using 37 to 80 pixels may enable one to resolve more than 10 layers. Moreover, since the problem can be over-determined, regularization can be applied penalizing the L1 or L2 norm of conductivity changes (the conductivity gradient and/or a function of conductivity or another transformed value). The regularization term weighting can be derived adaptively and may be based on one of several known approaches, such as Occam's inversion, L-curve, generalized cross-validation, etc.

The present disclosure also proposes related methods for visualization and quality control of directional resistivity measurement inversion-based interpretation. For instance, inversion output, misfits, regularization coefficient values, derived dip and formation consistency, and model covariance matrix (uncertainties), may be used. For embodiments that use Occam's inversion based interpretation, solutions for different values of regularization coefficients to evaluate uncertainties of the interpreted structure are also described herein.

In one possible implementation, a non-uniform inversion grid can be used to accelerate calculations in the creation of two dimensional formation models. Such an implementation can be used to facilitate, for example, real-time well placement.

### (i) Examples of 1D Inversion

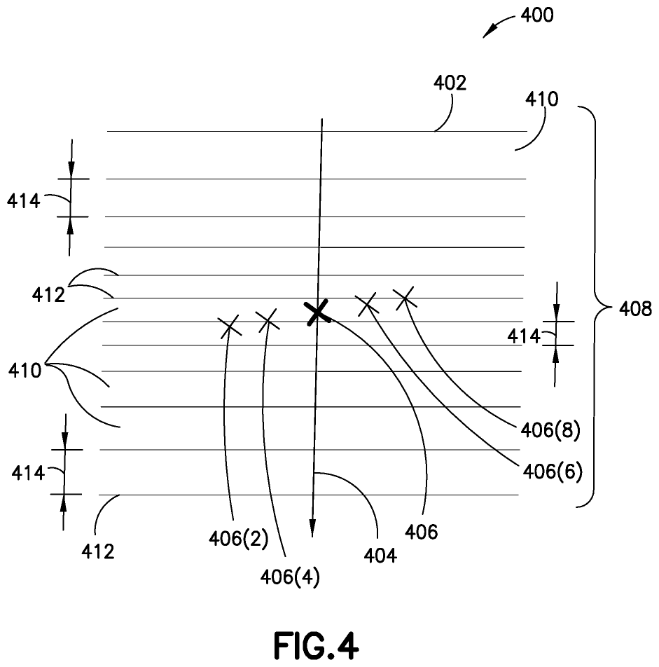

FIG. 4 illustrates a schematic visualization 400 of a 1D formation representation mapped with reference to a true horizontal length (THL) axis 402 and a true vertical depth (TVD) axis 404.

In one possible implementation, measurements taken by logging tool 300 at a data acquisition point 406 in borehole 102 can be inverted to create a formation representation in the form of a one dimensional (1D) formation model 408 associated with data acquisition point 406. Stated another way, 1D formation model 408 can approximate the layers of formation 142 as a plurality of pixels 410 bounded by gridlines 412 having infinite width, and finite thicknesses 414. 1D inversion can be conducted using any other techniques known in the art, including, for example, techniques described in PCT Application WO 2015/134455, which is incorporated herein by reference in its entirety.

Pixels 410 can have varying, non-uniform thicknesses 414 or uniform thicknesses 414 (though uniform thicknesses 414 may result in slower calculation times in accordance with some implementations of the two dimensional inversion).

In one possible embodiment, the number of pixels 410 can be larger than the number of physical layers of formation 142, such that gridlines 412 may not represent boundaries of formation 142. Rather, boundaries in formation 142 can be inferred, for example, from changes in resistivity depicted in 1D formation model 408.

In one possible implementation, 1D formation model 408 associated with data acquisition point 406 can be calculated using measurements from one or more additional data acquisition points 406(2), 406(4), 406(6), 406(8), etc., along borehole 102 adjacent to (e.g. in front of and/or behind) data acquisition point 406. In one possible aspect, using measurements from multiple additional data acquisition points 406(2), 406(4), 406(6), 406(8) can decrease noise and result in a more accurate 1D formation model 408 associated with data acquisition point 406.

For example, in one possible embodiment, measurements taken at ten or more additional data acquisition points 406 within a measurement window of, for example, 0.5 to 1 times the spacing between transmitter and receiver antenna on logging tool 300, can be used along with measurements taken at data acquisition point 406 in an inversion process. Use of additional measurements like these in the inversion process can render the inversion process more robust against noise.

It will be understood that data acquisition points 406 can represent points on a trajectory of borehole 102. Moreover, in some possible implementations, since logging tool 300 can acquire data and measurements continuously while moving along borehole 102, some data and measurements taken away from a precise geographical location of a given data acquisition point 406 can be associated with the given data acquisition point 406. For example, in one possible aspect, data and measurements collected by logging tool 300 up to ten or more feet away from a given data acquisition point 406 (either before or after the given data acquisition point 406) can be associated with the given data acquisition point 406.

Measurement windows can include as many or as few data acquisition points 406 as desired. In one possible implementation, a measurement window can include twenty one data acquisition points 406, though more or less data acquisition points 406 can also be used.

In one possible implementation, the inversion process discussed in conjunction with schematic visualization 400 can work well if the formation 142 is truly one dimensional. However, if formation 142 cannot be represented by a layered formation, using a measurement window of data acquisition points 406 in the inversion instead of a single data acquisition point 406 can lead to more artifacts in the inversion result.

In one possible implementation, instead of using a single 1D formation model 408 to fit the data of an entire measurement window, individual 1D formation models 408 can be created for each data acquisition point 406 in the measurement window and the various individual 1D formation models 408 can be tied together through regularization of the differences between them. Pixels 410 can dip with respect to a trajectory of logging tool 300 as it moves along borehole 102. In one possible implementation, each of the individual 1D formation models 408 can be discretized into a thin non-uniform distribution of pixels 410 based on measurement sensitivities in any way known in the art.

### (ii) Examples of 2D Inversion

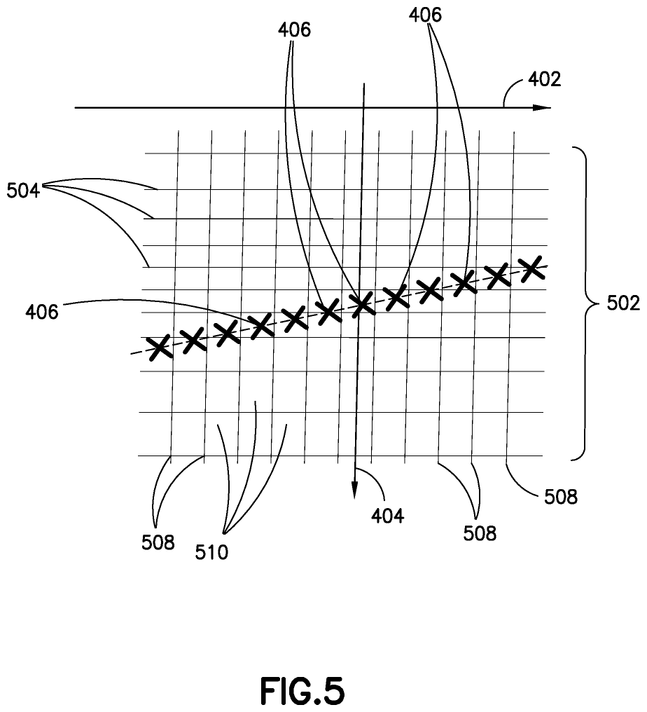

FIG. 5 illustrates an example two dimensional (2D) pixel grid 502 defined with reference to local true horizontal length (THL) axis 402 and true vertical depth (TVD) axis 404 in accordance with various embodiments of the present disclosure. In one possible implementation, a reference trajectory plane is generated from a trajectory orientation vector associated with a reference point on a trajectory of logging tool 300 moving through borehole 102, and a vector pointing towards the earth center, defining two dimensional (2D) pixel grid 502. Two dimensional pixel grid 502 can be made of gridlines 504 parallel to the THL axis 402, and gridlines 508 parallel to TVD axis 404 in any way known in the art. For example, in one possible implementation, spacing of gridlines 504 and 508 can be predetermined in any fashion known in the art.

For example, in one possible implementation, the spacing of gridlines 504 can result from analyzing the spacings between gridlines 412 (e.g. thicknesses 414 of pixels 410) in the various 1D formation models 408 associated with data acquisition points 406 in a measurement window. For instance, in one possible aspect, an averaging/regularizing of the thicknesses 414 of the various pixels 410 across the various 1D formation models 408 associated with the measurement window can be used to create the spacings between gridlines 504.

Thus, the spacings between gridlines 504 can be nonuniform throughout 2D pixel grid 502, though in some implementations it may be desirable to make the spacings between gridlines 504 uniform throughout 2D pixel grid 502.

The spacing of gridlines 508 can also be chosen using any method known in the art and can be nonuniform or uniform throughout 2D pixel grid 502 as desired. For example, in one possible implementation the grid size (e.g. the spacing between gridlines 508) can correspond to the distance between the individual data acquisition points 406 in the measurement window. In another possible implementation, spacing of gridlines 508 can be associated with a measurement depth of investigation of logging tool 300. For example, if logging tool 300 is capable of making measurements by sensing deep into formation 142, less data acquisition points 406 per unit distance along borehole 102 may be desired than if logging tool 300 is incapable of making measurements as deep into formation 142. In one possible implementation, distances between data acquisition points 406 (and thus distances between gridlines 508) can be between 0.5 and 1.0 meter, though greater and lesser distances can also be employed.

In one possible implementation, spacings between gridlines 504 and/or spacings between gridlines 508 can be set to create the largest possible grid sizing capable of achieving a desired resolution in 2D pixel grid 502 (including a minimum desired resolution) and/or in a resulting 2D formation model to be made from 2D pixel grid 502.

As illustrated in FIG. 5, pixels 510 in 2D pixel grid 502 have finite width and are bounded by horizontal gridlines 504 and vertical gridlines 508. In one possible implementation, once 2D pixel grid 502 has been formulated, it can be populated with information from the various 1D formation models 408 possibly used in its construction.

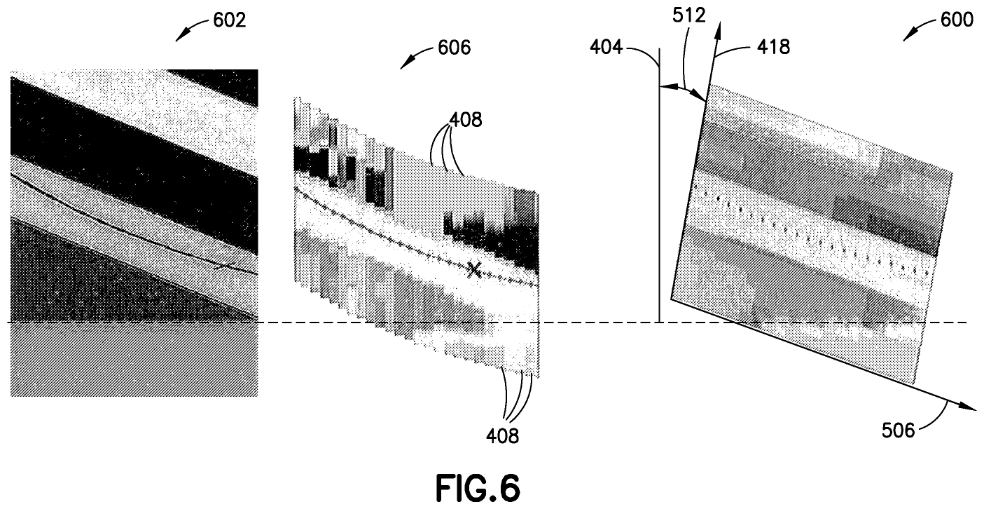

FIG. 6 illustrates an example 2D formation model 600 in accordance with various embodiments of the present disclosure. 2D formation model 600 can model an actual portion 602 of formation 142 by using a plurality of 1D formation models 408 in a curtain section model 606. In the instant example, 27 1D formation models 408 (corresponding to a measurement window of 27 data acquisition points 406) have been used to create curtain section model 606, though measurement windows with more or less 1D formation models 408 could also be used to create curtain section model 606.

It will be understood that the term “one dimensional inversion derived model” can include any model formed using at least some information from a one dimensional inversion. One dimensional inversion derived models can include, for example, 1D formation model 408, etc. Similarly, it will be understood that the term “two dimensional inversion derived model” can include any model formed using at least some information from a two dimensional inversion. Two dimensional inversion derived models can include, for example, 2D formation model 600, curtain section model 606, etc.

In one possible implementation, information from the 1D formation models 408 in curtain section model 606 can be used to populate 2D pixel grid 502. For example, 2D pixel grid 502 can be created with 21 pixels in the true horizontal depth in the direction of THL axis 402, which are 2 feet apart, and 36 non-uniform pixels in the true vertical depth (TVD) along TVD axis 404. These are mere examples, however, and it will be understood that other pixel values can also be used to create 2D pixel grid 502.

Once 2D pixel grid 502 is created, it can be populated in any way known in the art to form a populated two dimensional (2D) pixel grid 502. For example, in one possible implementation, a pixel 510 having a distinct address on the THL-TVD axis can be populated with a pixel value (such as one or more resistivity values, resistivity anisotropy values, etc.) found in a portion of a 1D formation model 408 at the same distinct address on the THL-TVD axis in curtain section model 606. Such a procedure can be followed for each pixel 510 in 2D pixel grid 502 such that all of pixels 510 are populated with pixel information from the various 1D formation models 408 used to create curtain section model 606.

In one possible implementation, horizontal resistivity (Rₕ) and vertical resistivity (Rᵥ) values from curtain section model 606 can serve as an initial approximation in calculating 2D formation model 600.

In one possible implementation, it may not be practical to choose too many pixels along the THL axis 402. Thus, any of various numbers of pixels 510 (and distances between pixels 510) known in the art can be chosen to make up each 2D formation model 600. In one possible embodiment, the number of pixels 510, and the distance between them can be chosen based on the depth of investigation of the logging tool 300 being used. For example, in one possible aspect, 21 pixels 510 using measured depth (MD) data acquisition points 406 spaced 2 feet apart can be used. In another possible aspect, 21 pixels 510 using MD data acquisition points spaced 4 feet apart can be used. If it is desired to process a longer interval of data, in one possible implementation, multiple individual approximate 2D formation models 600 can be launched and blended.

After 2D pixel grid 502 is populated with corresponding information from the various 1D formation models 408 to form a populated 2D pixel grid, such as 2D pixel grid 502, 2D pixel inversion can be used to transform the populated 2D pixel grid into 2D formation model 600. In one possible aspect, a cost function can be generated for the populated two dimensional pixel grid and used in the 2D pixel inversion.

In one possible implementation, inversion minimizes a cost function in terms of difference between a modeled response of logging tool 300 and actual measurements acquired by logging tool 300, sometimes referred as the error term, through adjusting the model of the formation, defined by geometry and properties.

The cost function may be augmented with an additional regularization term and the balance between the error and the pixel regularization can be determined heuristically (see e.g., Dennis et al., “Numerical Methods for Unconstrained Optimization and Non-Linear Equations,” SIAM Classics in Applied Mathematics (1996); Nocedel et al., “Numerical Optimization,” 2nd ed. Springer Series in Operations Research (2006)) or managed by adaptive regularization methods (see e.g., Constable et al., “Occam's Inversion: A Practical Algorithm for Generating Smooth Models from Electromagnetic Sounding Data,” Geophysics, vol. 52, no. 3, pp. 289-300 (1987); Farquharson et al., “A Comparison of Automatic Techniques for Estimating the Regularization Parameter in Non-Linear Inverse Problem,” Geophys. J. Int. 156, pp. 411-425 (2004)). In 1D inversion, the forward modeling code used may be a standard semi-analytical algorithm which computes the response of point dipoles in a layered anisotropic 1D medium.

In operation, 2D pixel inversion differs from 1D inversion in that the Rₕ and Rᵥ differences between pixels 510 can be penalized in two directions, compared to a single penalization along TVD axis 404 for pixels used in original 1D pixel-based inversion. Pixel penalization along the perpendicular direction of THL axis 402 can be independent of pixel penalization along TVD axis 404. In one possible implementation, 2D pixel inversion can be done without use of total variation regularization. Additionally, 2D pixel inversion can use the Huber error term φ(y):

$$ϕ ( y ) = \{ \begin{matrix}{y}^{2} & \vert y \vert \leq Δ \\ 2 δ ( \vert y \vert - 0.5 Δ ) & \vert y \vert y > Δ\end{matrix} ,$$

and the approximate L1-norm regularization, as in 1D pixel inversion. In addition, the inversion error term weights wₖ in 2D pixel inversion can be the same as in 1D inversion. Moreover, compared to the 1D pixel inversion cost function (not showing the total variation regularization):

$$C ( x ) = \frac{1}{2} {\sum }_{k} {{w}_{k}^{2} ( {d}_{k}^{obs} {f}_{k} ( x ) )}^{2} + \frac{1}{2} {λ}_{T V D} {\sum }_{i} \sqrt{{{w}_{TST , i}^{2} ( {x}_{i} {x}_{i - 1} )}^{2} + {c}^{2}}$$

the 2D pixel inversion cost function can have one extra term corresponding to THL axis 402 as follows:

$$C ( x ) = \frac{1}{2} {\sum }_{k} {{w}_{k}^{2} ( {d}_{k}^{obs} {f}_{k} ( x ) )}^{2} + \frac{1}{2} {λ}_{T V D} {\sum }_{i} \sqrt{{{w}_{TVD , i}^{2} ( {x}_{i} {x}_{i - 1} )}^{2} + {c}^{2}} + \frac{1}{2} {λ}_{THL} {\sum }_{i} \sqrt{{{w}_{THL , i}^{2} ( {x}_{i} {x}_{i - 1} )}^{2} + {c}^{2}}$$

The first cost function term is the data error term, with weighted differences between the measurement (observed) data (dₖ^{obs}) and modeled responses fₖ(x), the second is the pixel difference regularization along TVD axis 404 and the third term is the pixel difference regularization along THL axis 402 perpendicular to TVD axis 404. In one possible implementation, λ_{TVD} and λ_{THL} can balance the two regularization terms against the residual and can be estimated using any adaptive regularization technique known in the art, including for example, Occam's method, L-curve techniques, generalized cross-validation, etc. In each iteration, the Gauss-Newton step (as a function of λ_{TVD} and λ_{THL}) that reduces the residual the most can be found.

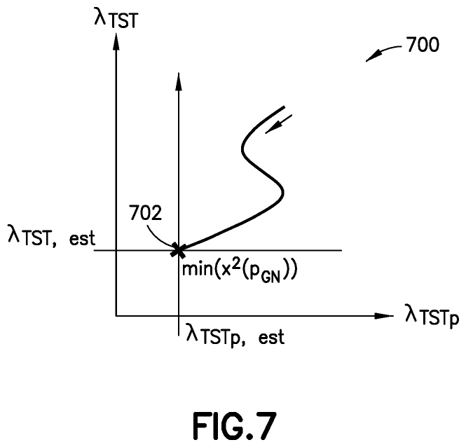

FIG. 7 illustrates a visualization 700 of Occam's method to estimate gradient penalization constraints in accordance with embodiments of enhanced two dimensional inversion. In one possible implementation, a search can implemented in an efficient way to save computational time by starting from (λ_{TVD}, λ_{THL}) of the previous iteration. A line-search can be used, adjusting λ_{TVD,new}=c₁*λ_{TVD} and λ_{THL,new}=c₂*λ_{THL} iteratively. A search direction for the minimum can be c₁=c₂=2/3 (or 3/2) and when a minimum is found in this direction, the search can continue in the perpendicular direction c₁=3/2 and c₂=2/3 (or c₁=2/3 and c₂=3/2). This can be iterated until the minimum 702 is found. In one possible aspect, a starting point for the first Occam search can be λ_{THL}=1.0 and λ_{TVD}=0.1. If the first Occam search can't find a Gauss-Newton step that reduces the minimum λ_{TVD}=5*10⁻⁵ then λ_{THL}=10⁻³ can be chosen. During the inversion, λ_{THL}>λ_{TVD} can be enforced to ensure lateral consistency. In one possible implementation, a 2D Occam search as described above can lead to an average of approximately ten forward model calls per inversion iteration.

In one possible embodiment, for each inversion iteration in 2D pixel inversion, calculation of the first derivatives of the measurement response with respect to pixel resistivities can be desirable. This can be achieved, for example, through finite differences by perturbing each pixel 510 separately and calculating the measurement response of the modeled formation with the perturbed pixel 510. However, in one possible aspect the forward model can be called for the data acquisition point 406 of the pixel column (i.e. pixels 510 stacked in the direction of TVD axis 404) to which the perturbed pixel 510 belongs in order to get a difference in the simulated response. In one possible embodiment, it is possible to compute the derivatives using the adjoint variable technique in the forward modeling used in an inversion loop.

In one possible implementation a minimum penalization along THL direction 402 can be enforced so that lateral consistency across pixel columns is ensured. This can be achieved, for example, by enforcing λ_{THL}>λ_{TVD}.

(iii) Examples of Enhanced 2D Inversion

In one possible implementation, the techniques of 2D inversion disclosed herein may be desirable in modeling areas of formation 142 with one or more two dimensional (2D) formation features (such as, for example, a fault, etc.) through deployment of 2.5D tool response modeling.

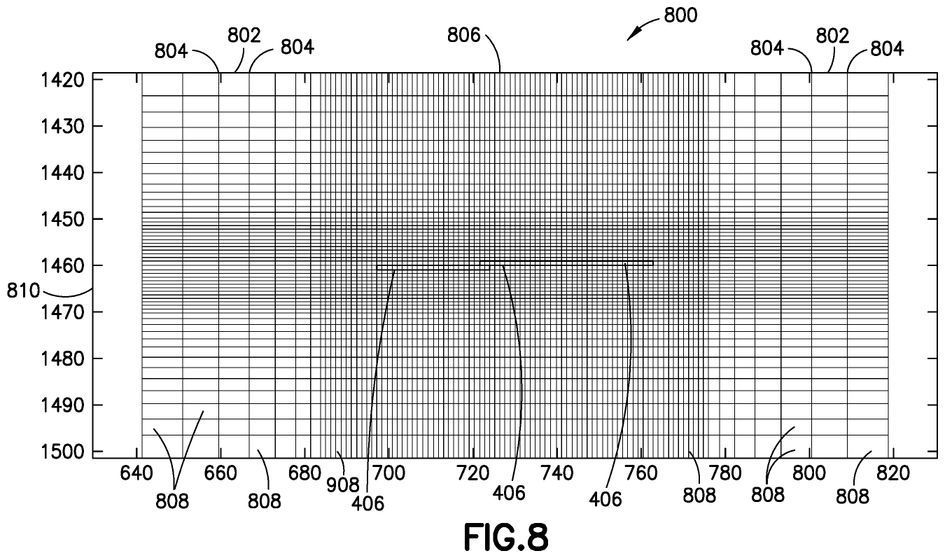

FIG. 8 illustrates an example two dimensional (2D) pixel inversion domain forming a 2D resistivity inversion pixel grid 800 for low relative angle inversion in accordance with various embodiments of the present disclosure. In the instant case, 2D resistivity inversion pixel grid 800 is associated with a two receiver (short and long spacing data, receivers R1 and R2) inversion with 54 data acquisition points 406 and an antenna spacing of 12.5 m (Tx-R1) and 25 m (Tx-R2). Other inversions with more or less data acquisition points 406, more receivers, and different antenna spacings can also be used.

In one possible implementation, it may be desirable to choose a window of data acquisition points 406 covering at least two times the longest antenna spacing on measurement logging tool 300 such that the window includes all data in which one or more transmitters 302, 304, 306, 308, 310 and 312 and receivers 314, 316, 318, and 320 cross a 2D formation feature being modelled in formation 142. In one possible embodiment, for the sake of simplicity, equally spaced pixel columns 802 formed by vertical gridlines 804 along true horizontal length (THL) axis 806 can be chosen and spaced at any desirable distance, including for example 1 m, 4 ft, etc. Any number of columns 802 can be created. In one possible implementation, at least 41 columns 802 can be created if one spacing (such as, for example, using one transmitter sub and one receiver sub) is used. In another possible implementation, 54 columns 802 including data can be formed if two spacings (such as, for example, one transmitter sub and two receiver subs and/or two transmitter subs and one receiver sub and/or two pairs of transmitter and receiver subs, etc.) are used (such as, for example when regular spacing is used with measurement logging tool 300 with ˜10 m and ˜20 m Tx-Rx spacing).

In one possible implementation, for each pixel column 802, one or more data acquisition points 406 can be chosen. Pixels 808 along true vertical depth (TVD) axis 810 can cover the area from min(TVD_{data points})−2*spacing_{long} to max(TVD_{data points})+2*spacing_{long}, where spacing_{long} indicates a largest transmitter-receiver spacing in use. For example, a distribution of pixels 808 along TVD 810 can follow the distribution of pixels 808 in the various 1D formation models 408 filled with additional thin pixels between min(TVD_{data points}) and max(TVD_{data points}). Along THL 806, pixels 808 can be equally spaced between min(THL_{data points})−0.5*spacinng_{long} and max(THL_{data points})+0.5*spacing_{long}.

In one possible implementation, in order to discretize the formation ahead and behind the processed data interval within the measurement sensitivity range, pixel columns 802 with exponentially increasing width can be placed up to min(THL_{data points})−2.5*spacing_{long} and up to max(THL_{data points})+2.5*spacing_{long}.

In one possible aspect, it may be noticed that no appreciable relative variation between λ_{THL} and λ_{TVD} exists, such that most inversions settle with a penalization distribution close to λ_{THL}=3.0*λ_{TVD}. Thus, in one possible implementation, λ_{THL}=3.0*λ_{TVD} can be chosen from the beginning of the 2D inversion process, and the Occam search can be simplified, since the value for λ_{TVD} is what is sought. In one possible aspect, approximately six forward model calls per inversion iteration on average can be used. In addition, λ_{THL}=3.0*λ_{TVD} can ensure consistency of the inverted 2D pixel model (i.e. the full two dimensional formation model) created using 2D resistivity inversion pixel grid 800 along THL axis 806.

In one possible implementation, because of the runtime of the 2.5D forward model used in 2D inversion, parallelization can be used. For example, instead of computing the tool responses for all N data acquisition points 406 of the inversion data window sequentially, the tool responses can be calculated simultaneously and compute response in each data acquisition point 406 at the same time if computing resources are available. This can reduce the tool response generation to almost 1/N of the time of a sequential (non-parallel) response simulation (assuming that the same resources, at least N cores, are available for the computation). Furthermore, responses at each frequency can be modeled in parallel as well, so N data acquisition points 406 with responses for M frequencies can result in parallel N*M response simulations for different frequencies and data acquisition points.

As noted above, in embodiments of 2D pixel-based inversion, a long interval of data can be processed by running multiple overlapping 2D inversions. The pixels ahead and behind the processed interval can then be removed before merging the individual solutions to create 2D formation model 600.

In many instances, it may not be necessary to process a long interval of data using 2D inversion. For instance, if 1D formation models 408 can fit the data well but there is one measured depth (MD) interval where the residual and misfit is high, a localized 2D feature (such as, for example, a fault) was likely crossed. Then a single 2D pixel inversion centered at the high residual/misfit interval can resolve the 2D feature and the 2D pixel inversion result blended into the 1D inversion result may be sufficient to fully explain the data.

(iv) Examples of Updating Measurement Generation for 2D Inversion with 3D Trajectory

In some implementations above, the imaging plane is defined as the reference trajectory plane. For example, in some embodiments, a portion of the trajectory of logging tool 300 has been described as being located in a 2D imaging plane of 2D formation model 600. In one possible aspect, the portion of the trajectory of logging tool 300 is chosen to be approximately ten meters long and is assumed to be straight. It will be understood however, that other lengths of the trajectory of logging tool 300 greater or less than ten meters may also be chosen to be the portion of the trajectory of logging tool 300).

In addition to the implementations above, it will also be noted that other possible implementations exist (such as when, for example, lateral discontinuities and/or rapid structural changes exist in formation 142) where it may be desirable to create an imaging plane that does not coincide with the reference trajectory plane in order to better represent formation 142 given the measurements collected regarding formation 142. In one possible aspect, the imaging plane can be at any possible orientation with respect to the reference trajectory plane, and inversion can be performed to determine an arbitrary 2D formation model in the imaging plane from data acquired along at least a portion of the 3D trajectory of logging tool 300. Such a methodology can be used, for example, to enable imaging of discontinuities in formation 142, such as lateral discontinuities, and can be used in various endeavors, including well placement application steering with respect to formation changes on a side of borehole 102, such as steering with respect to a lateral fault, in channel sands, etc.

In one possible implementation, to create an imaging plane with an orientation different than that of the reference trajectory plane, 2D inversions for a general 3D trajectory of logging tool 300 can utilize an extension of a standard measurement set recorded by, for example, logging tool 300, in order to generate one or more of the electromagnetic coupling components provided by logging tool 300. In some possible aspects, real-time measurements can be designed for interpretation assuming a 1D layered formation model with transversely isotropic electromagnetic properties in each layer (408). In one possible embodiment, such a measurement generation setup can be tailored towards recovering a 1D layered structure of formation 142.

In one possible embodiment, additional measurements by logging tool 300 with 3D sensitivities can be defined as 3D indicators that can characterize additional non-1D formation characteristics. Processing of such measurements can start by finding an equivalent bedding azimuth for each coupling. However, in some instances, such measurement definitions may not be practical for quantitative 2D/3D interpretation, such as that accomplished through an inversion algorithm.

Therefore, in some instances it may be desirable to create an extension of measurement generation from whatever electromagnetic coupling components might be employed in order to form a more complete measurement set (i.e. a measurement set including information that can be extracted from the electromagnetic coupling components). Further, in some possible aspects, such a more complete measurement set can be tailored towards inversion for translationally invariant 2D formations (with corresponding orientation angles) and/or full 3D formation property distributions.

In one possible implementation, measurement generation for a 2D inversion with a 3D trajectory can be updated. For example, with regard to measurement generation for 1D and/or curtain section 2D, inductive EM coupling between triaxial (x, y, z oriented) transmitter and receiver antennas in space (such as transmitters 302, 304, 306, 308, 310 and 312, and receivers 314, 316, 318, and 320 on logging tool 300) can be represented by a 3×3 tensor with coupling components as follows:

$$( \begin{matrix}xx & xy & xz \\ yx & yy & yz \\ zx & zy & zz\end{matrix} )$$

where the first character denotes the transmitter orientation and second character denotes the receiver orientation, ie. “xy” indicates the measured voltage at a y-directed receiver antenna from a x-directed transmitter dipole. These tensor components can be used to construct couplings of arbitrary, axial, transverse and/or tilted antennas and/or of their combinations and arrangements.

In one possible aspect, components of such a 3×3 EM tensor can be used to construct measurements with different spatial sensitivities to characterize resistivity and structure of areas of formation 142. For instance, the above couplings can change when logging tool 300 rotates around its longitudinal tool axis, with the exception of zz which is azimuthally invariant, since z is the rotational axis of logging tool 300.

In one possible embodiment, based on changes associated with a rotation of logging tool 300 by an angle φ around its longitudinal axis, the couplings can be classified into three categories:
1. Rotationally invariant couplings (called 0th harmonic, or “H0”-measurements): zz, (xx+yy)/2 and (xy−yx)/2
2. First harmonic couplings with a sin φ azimuthal dependence (called “H1”-measurements): xz, zx, yz, zy
3. Second harmonic couplings with a sin 2φ dependence (called “H2”-measurements): (xx−yy)/2 and (xy+yx)/2.

In one possible aspect, the H1- and H2-measurements may be associated with the coordinate system used. In one possible convention, for processing assuming a 1D layered formation, the tool coordinate system can be rotated around the z-axis (the rotational axis of logging tool 300) so as to decrease and/or minimize couplings in the y-direction (such as, for example, yz, zy, xy and yx).

In one possible aspect, if the triaxial EM data is acquired in a 1D layered formation (or if formation 142 is 2D in the reference trajectory plane that includes a portion of the trajectory of tool 300, invariant laterally), the cross-dipole couplings with y-directed antennas can be zero after rotation to a reference plane perpendicular to bedding, and the five non-zero couplings can remain:

$$( \begin{matrix}xx & 0 & xz \\ 0 & yy & 0 \\ zx & 0 & zz\end{matrix} )$$

The five non-zero couplings can be used to form four independent propagation style (ratio) measurements:
1. Harmonic resistivity (UHR):

$$\frac{xx + yy}{2 zz}$$

2. Symmetrized directional measurements (USD):

$$\frac{zz + zx}{zz - zx} \frac{zz - xz}{zz + xz}$$

3. Anti-symmetrized directional measurements (UAD):

$$\frac{zz + zx}{zz - zx} \frac{zz + xz}{zz - xz}$$

4. Harmonic anisotropy measurements (UHA):

$$\frac{xx}{yy}$$

This measurement definition may also be applicable in a non 1D layered formation, i.e. since the cross-dipole couplings with the y-directed antennas are non-zero after rotation to a reference plane perpendicular to bedding. In such an instance, additional responses can be formed to enhance sensitivity to the 3D formation features:
5. 3D H0 measurement:

$$xx + yy + xy - yx$$

$$xx + yy - xy + yx$$

6. 3D H0 measurement:

$$\frac{zz + xy - yx}{zz - xy + yx}$$

7. 3D H1 symmetrized directional measurement (lateral):

$$\frac{zz + zy}{zz - zy} \frac{zz - yz}{zz + yz}$$

8. 3D H1 anti-symmetrized directional measurement (lateral):

$$\frac{zz + zy}{zz - zy} \frac{zz + yz}{zz - yz}$$

9. 3D H2 measurement (aka Second Harmonic Anisotropic Measurement):

$$\frac{x x + y y + x y + y x}{xx + y y - x y - yx}$$

From the above measurement set, 3D H1 symmetrized is an equivalent of a 3D indicator called “3D formation lateral indicator or U3DF” in a reservoir mapping-while-drilling service, such as, for example, the GEOSPHERE reservoir mapping-while-drilling service of Schlumberger Technology Corporation. In one possible aspect, 3D H0 measurements

$$\frac{x x + y y + x y - y x}{xx + y y - x y + yx}$$

can De used as a “3D longitudinal indicator” such as described in, for example, in U.S. Pat. No. 8,754,650, issued on Jun. 17, 2014, which is hereby incorporated herein by reference in its entirety.

In one possible implementation, with regard to three dimensional (3D) effects, measurements can be defined for 1D formations and/or laterally invariant 2D formations. In such scenarios, cross-dipole antenna couplings including a y-directed transmitter and receivers can be zero, and the UHR, USD, UAD and UHA channels can be used in interpretation.

In contrast, if formation 142 is not translationally invariant, the cross-dipole couplings including y-directed antennas may not be zero. In such cases, logging tool 300 may measure a non-zero U3DF response (constructed, for example, by using the zz-, zy- and yz-couplings), which can be used in real time for qualitative interpretation along with bedding azimuth angles. In one possible aspect, discontinuities along the true horizontal length (THL) that come at an angle with respect to the y-axis can be simulated and the change in the measurement responses with this angle can be calculated. For instance, in one possible embodiment, regarding a response of logging tool 300 at various angles with respect to the y-axis, up to around a 30° angle (with respect to the y-axis), the response may not change appreciably. Alternately, or additionally, beyond 30° the responses of logging tool 300 may be noticeably affected. In such instances, response complexity may cause artifacts in the inverted formation model if the angle of the discontinuity is ignored. For example, a non-zero azimuth angle may make an effective bedding orientation from the 2^{nd} harmonic data non-zero for horizontal layers with true zero azimuth, so a false relative formation azimuth angle can be estimated around the discontinuity.

In one possible implementation, in a 3D environment with strong formation heterogeneities in each direction, rotation of the coordinate system to decrease and/or minimize all couplings in the y-direction can become unstable and produce fast changing, nonsmooth complex responses because of a circularly polarized wave nature of the field.

In such an instance, 2D and/or 3D subsurface features of formation 142 may not be easily recovered from the standard measurement set, since non-smooth measurements may result in a complex and multimodal cost function, causing difficulties in minimization, leading to interpretation problems. In one possible aspect, in some 3D scenarios, equivalent bedding azimuth angles which themselves differ can be used to rotate the couplings. Consequently, in some possible implementations, a measurement definition that does not involve a rotation of the coordinate system may be desirable, and can be used in a full 2D/3D inversion to interpret the responses of the full 2D/3D inversion. Such a non-rotated coordinate system can have an x-axis pointing uphole (towards surface 138) and a z-axis can be along a longitudinal axis of logging tool 300. Correspondingly, a y-axis can be perpendicular and point to the right to complete a right-handed coordinate system. With this example definition, a more complete measurement set (nine independent ratio measurements resulting from, nine couplings) can be derived from the coupling tensor following the measurement definitions of 1-9 above:

A. Harmonic resistivity UHR (UH0):

$$\frac{x x + y y}{2 z z}$$

B. Second (3D) Zeroth Harmonic UH0XY:

$$\frac{xx + y y + xy - yx}{x x + y y - xy + yx}$$

C. Third (3D) Zeroth Harmonic UH0XYZ:

$$\frac{z z + xy - yx}{z z - xy + yx}$$

D. Symmetrized directional (SD) x-directed USDX:

$$\frac{z z + z x}{z z - z x} \frac{zz - xz}{zz + xz}$$

E. Symmetrized directional (SD) y-directed USDY:

$$\frac{z z + z y}{z z - z y} \frac{zz - yz}{zz + yz}$$

F. Anti-symmetrized directional x-directed UADX:

$$\frac{z z + z x}{z z - z x} \frac{z z + x z}{z z - x z}$$

G. Anti-symmetrized directional y-directed UADY:

$$\frac{z z + z y}{z z - z y} \frac{z z + y z}{z z - y z}$$

H. Harmonic Anisotropy measurements UHAX:

$$\frac{x x}{y y}$$

I. Second (3D) Harmonic Anisotropy measurements UHAXY:

$$\frac{x x + y y + x y + y x}{xx + y y - x y - yx}$$

In one possible implementation, processing measurements using the new measurement set definitions A-I can result in smooth responses which may be desirable for general 2D and 3D inversion algorithms, since the responses may be less likely to produce local minima.

### (v) Examples of 2D Pixel Inversion With 3D Trajectory

FIG. 9 illustrates an example coordinate system 900 of an imaging plane 902 as it initially aligns with a reference trajectory plane 904 in accordance with various embodiments of the present disclosure. In one possible implementation, imaging plane 902 is a plane in which inversion (including, for example, a 2D pixel inversion, etc.) can be conducted in order to estimate electromagnetic property distribution (isotropic and/or anisotropic resistivities and/or permittivities) in formation 142. Imaging plane 902 can include a description of a 2D structure, including, for example, the approximate 2D formation model 606 that is a result of 1D inversion, the 2D formation model 600 that is result of approximate or full 2D inversion, a 2D model plane in which formation 142 is defined with polygons and/or triangles, etc. Similarly, reference trajectory plane 904 is a plane in which at least a portion of a trajectory 906 of logging tool 300 and/or borehole 102 can be found. Reference trajectory plane 904 can be called a variety of names including, for example, a TVD-THL plane, and may coincide with the curtain section plane if the trajectory azimuth is not changing in a section, etc.

In one possible implementation, two strategies can be defined for a 2D inversion-based workflow associated with 3D trajectory 906 of logging tool 300. For example, given a low relative azimuth angle of imaging plane 902 with respect to trajectory 906 (for example, up to 60 degrees in both directions), 1D inversion results in reference trajectory plane 904 can be used as an initial approximation for the full 2D inversion of a resistivity distribution, and an initial approximation for a relative orientation between imaging plane 902 and trajectory 906 (such as, for example, a relative polar angle β, and an azimuth angle α of imaging plane 902 with respect to trajectory 906).

It will be understood that the term “resistivity” as used herein can mean any electromagnetic property. Moreover, it will be understood that resistivity can be anisotropic.

Alternately, or additionally, if trajectory 906 is at a high azimuth angle with respect to imaging plane 902 (for example, greater than 60 degrees in both directions), it may be desirable to start with an assumption that imaging plane 902 is perpendicular to trajectory 906, rotating imaging plane 902 away from a perpendicular to trajectory 906 through use of a relative polar angle β and a relative azimuth angle α.

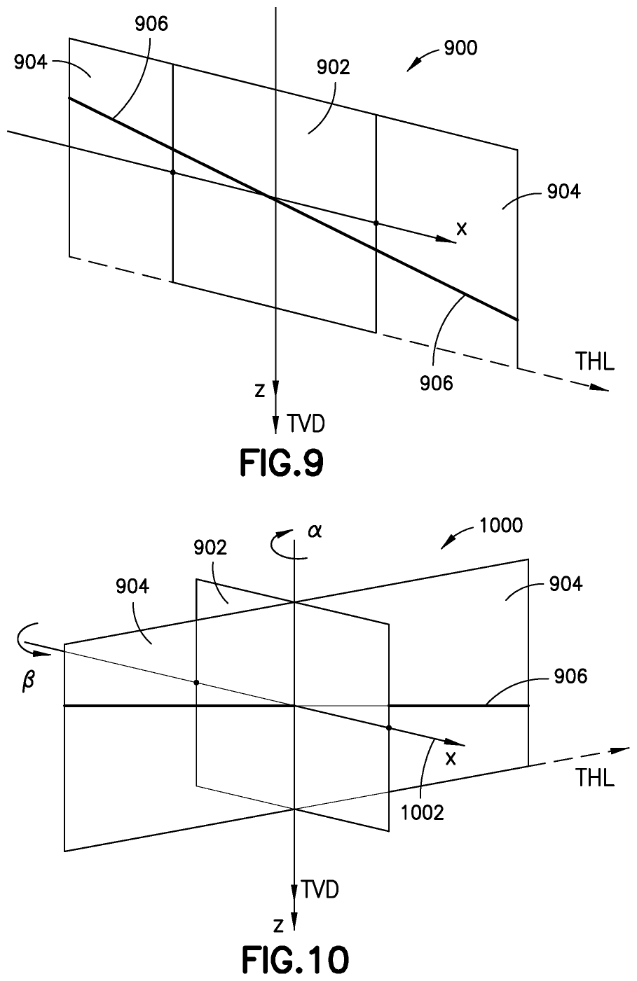

FIG. 10 illustrates an example coordinate system 1000 that can be used in a 2.5D solver relative to a THL and TVD of trajectory 906 for a regular 2D inversion after rotation of trajectory 906 with an azimuth angle α and a relative polar angle β (with β=0) in accordance with various embodiments of the present disclosure. As noted above, coordinate system 900 used in the 2.5D forward modeling algorithm can align with THL-TVD, defined with reference to trajectory 906, as used for curtain section 2D inversion (including, for example, curtain section 2D pixel inversion, etc., with x=THL, y=0, z=TVD) in reference trajectory plane 904, as shown in FIG. 9. In contrast, however, in one possible embodiment, with trajectory 906 at an azimuth angle α with respect to imaging plane 902, imaging plane 902 can remain in the xz-plane (i.e. reference trajectory plane 904) and the trajectory points can be rotated around the z-axis, (x=THL cos(α), y=THL sin(α), z=TVD) as shown in FIG. 10.

In one possible aspect, the relative polar angle β of imaging plane 902 can be defined as the rotation of one or more points on trajectory 906 around the x-axis 1002. The trajectory points can then be (x_{new}=x, y_{new}=y cos(β) z sin(β), z_{new}=y sin(β)+z cos(β)), such that the final trajectory point can equal:

$${P}_{n e w} = ( \begin{matrix} & THL cos ( α ) & \\ THL & sin ( α ) cos ( β ) TVD & sin ( β ) \\ T H L & sin ( α ) sin ( β ) + TVD & cos ( β )\end{matrix} ) .$$

After coordinate transformation, the corresponding relative inclination and azimuth angles can be adjusted accordingly. For instance, in the original curtain section definition for constant azimuth trajectory with α=β=0° the orientation of logging tool 300 corresponding to the inclination φ can be d=(sin(φ), 0, cos(φ)). Transformed the same way as the trajectory points, the orientation of logging tool 300 can become:

$${d}_{n e w} = ( \begin{matrix} & & sin ( ϕ ) cos ( α ) & \\ sin ( ϕ ) & sin ( α ) & cos ( β ) cos ( ϕ ) & sin ( β ) \\ sin ( ϕ ) & sin ( α ) & sin ( β ) + cos ( ϕ ) & cos ( β )\end{matrix} ) .$$

The relative inclination can then be:

φᵢₙ=a cos(d_{new,z})=a cos(sin(φ)sin(α)sin(β)+cos(φ)cos(β)),

and the corresponding azimuth can be:

$${α}_{i n} = atan ( \frac{{d}_{new , y}}{{d}_{new , x}} ) = atan ( \frac{sin ( ϕ ) sin ( α ) cos ( β ) - cos ( ϕ ) sin ( β )}{sin ( ϕ ) cos ( α )} ) .$$

### (vi) Example 2D Inversion for Low Relative Azimuth Starting From the Reference Trajectory Plane

As noted above, in one possible implementation, when imaging plane 902 is assumed to have a low azimuth angle α with respect to trajectory 906, results of one or more 1D inversions can be used as an initial approximation in a 2D inversion, with azimuth angle α of imaging plane 902 being estimated with respect to reference trajectory plane 904. In one possible aspect, a low azimuth angle α can include any azimuth angle α up to 60 degrees in both directions.

In one possible embodiment, a setup of a domain of the 2D inversion can include 2D pixel curtain section inversion with an added relative azimuth angle α. For example, with regard to 2D pixel inversion with azimuth implementation, both (1) azimuth angle α (and relative polar angle β), and (2) electromagnetic properties (including, for example, anisotropic resistivity values) in each pixel, can be inverted for. Moreover, if azimuth angle α can be assumed to be relatively small (such as up to 60 degrees in both directions, for example), reference trajectory plane 904 and imaging plane 902 can be seen as being oriented relatively close to one another.

In one possible aspect, 2D curtain section inversion, such as, for example, inversion conducted in reference trajectory plane 904, can be adapted by adding azimuth angle α and relative polar angle β. In one possible aspect, the derivative of responses with respect to the angles α and β can be computed using finite differences with a second forward model call with a slightly perturbed angle α and angle β. In one possible embodiment, the projection of a 2D formation structure onto reference trajectory plane 904 will not change with relative azimuth angle α, ensuring a stable inversion. The 2D formation structure can be compressed along the x-axis, and can be adjusted with the azimuth angle α, x_{new}=x₀ cos(α), where x₀ is the reference position of a given point in the 2D formation structure at α=0 so that a given point along trajectory 906 remains in the same cell of the 2D formation structure independent of the azimuth angle α.

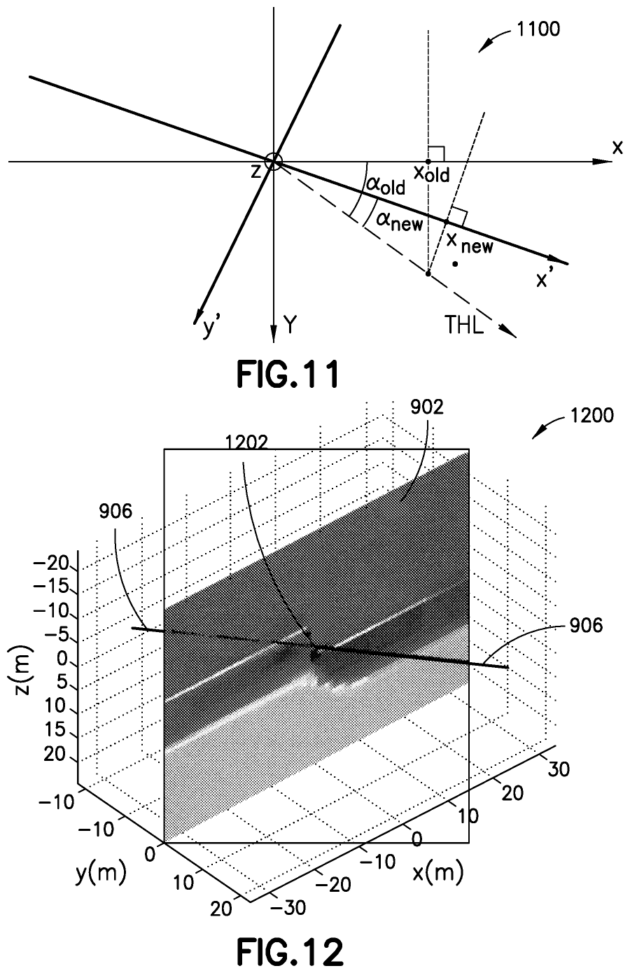

FIG. 11 illustrates an example update 1100 of an extension of the 2D formation structure with a change of relative azimuth angle α in accordance with various embodiments of the present disclosure. In one possible embodiment, the relative polar angle β can be set to zero.

FIG. 12 illustrates an example 2D inversion result 1200 in 3D space in accordance with embodiments of enhanced two dimensional inversion. As shown in 2D inversion result 1200, imaging plane 902 is the xz-plane and trajectory 906 is at a relative azimuth angle α=45 degrees away from imaging plane 902. Result 1200 shows that a 2D feature 1202, such as a fault, etc., is being crossed.

In one possible implementation, in order to perform an inversion in accordance with concepts of 2D inversion for low relative azimuth, one or more 1D inversions (such as 1D formation models 408 assembled into curtain section model 606) can be used to generate one or more initial approximations of the electromagnetic properties (such as resistivity and resistivity anisotropy distribution) of the 2D imaging plane 902, using any techniques known in the art. The resistivity and resistivity anisotropy distribution of the 2D imaging plane 902 can include various resistivity and resistivity anisotropy values.

For example, in one possible implementation, curtain section model 606 can be mapped onto grid 800, thus populating grid 800 with pixel resistivity and resistivity anisotropy information of 2D imaging plane 902, creating 2D formation model 600. In one possible aspect, the pixel resistivity information can comprise one or more resistivity profiles, and the resistivity anisotropy information can comprise one or more resistivity anisotropy profiles.

In one possible aspect, a non-uniform inversion grid (such as grid 800) can be used to accelerate calculations in the creation of one or more 2D formation models 600. One or more initial approximations as to a relative azimuth a may then be made. In one possible aspect, various starting values for one or more initial approximations as to the relative azimuth a can be used, such as, for example, −55 degrees, −10 degrees, 10 degrees, 55 degrees, etc. In one possible embodiment, pixel width can automatically be adjusted with azimuth angle α. Such automatic adjustment can be accomplished using any method known in the art, including, for example, the techniques described above in conjunction with FIG. 11.

In one possible embodiment, a first inversion can be performed to determine an orientation of a 2D plane associated with the 2D formation model relative to reference trajectory plane 904. In one possible embodiment, the 2D plane associated with the 2D formation model is imaging plane 902.

The results of the first inversion can be anything known in the art defining an orientation of the 2D plane associated with the 2D formation model relative to reference trajectory plane 904.

A second inversion can be performed to determine one or more electromagnetic property values such as, for example, resistivity and resistivity anisotropy values for the 2D formation model. The two inversions can be stages of a 2D inversion-based workflow for low relative azimuth angle α. In one possible implementation, the parameters inverted in the first inversion and the second inversion can be determined simultaneously in a single inversion, while in another possible implementation, the first inversion and the second inversion can be run sequentially.

In one possible embodiment, in addition to azimuth angle α, relative polar angle β may also be inverted for.

In one possible aspect, in curtain section and/or in small azimuth inversion as described above, the data associated with the plurality of positions of logging tool 300 along the trajectory 906 can be applied to data windows, such as, for example, data windows two times or more times the Tx-Rx spacing.

(vii) Example Full 2D Inversion With Relative Azimuth Starting From a Perpendicular Plane

In one possible implementation, 2D inversion can be pursued by assuming that imaging plane 902 is at a high azimuth angle α with respect to the trajectory of logging tool 300 (i.e. trajectory 906 and/or reference trajectory plane 904). In such an implementation, 1D inversion results may not be desirable as a starting point, so the full 2D inversion process can instead start by assuming that imaging plane 902 is perpendicular to the reference trajectory plane 904, i.e. has an azimuth angle α of 90 degrees to the trajectory of logging tool 300. Inversion can then be conducted to find an orientation of imaging plane 902 with a relative polar angle β and an azimuth angle α with respect to reference trajectory plane 904 which allows for an accurate definition of a model of formation 142.

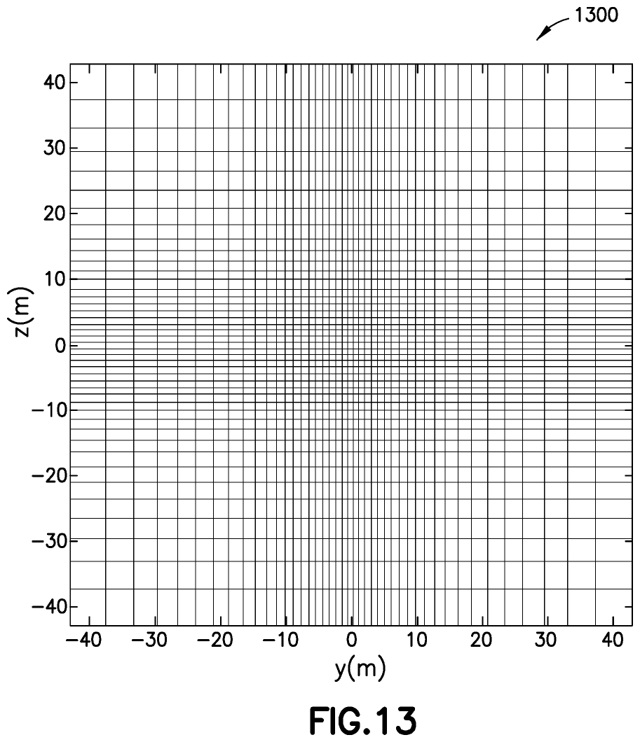

FIG. 13 illustrates an example non-uniform inversion grid 1300 for high relative angle inversion in accordance with various embodiments of the present disclosure. As illustrated, inversion grid 1300 is for a measurement system with single transmitter and two-receivers, with Tx-Rx antenna spacing of 13.0 m and 21.0 m, wherein the inversion is associated with a reservoir mapping-while-drilling service (such as, for example, the GEOSPHERE reservoir mapping-while-drilling service of Schlumberger Technology Corporation). It will be understood, however, that other inversion grids associated with different numbers of transmitters (such as transmitters 302, 304, 306, 308, 310 and 312) and receivers (such as receivers 314, 316, 318, and 320), and different spacings of transmitters and receivers, can also be used with the two dimensional inversion described herein.

In one possible aspect, a high relative azimuth angle α (such as, for example, around 90 degrees) of imaging plane 902 allows the inversion to image changes of formation 142 to the side of borehole 102 for horizontal or near-horizontal wells (in addition to vertical changes). With such an inversion approach, features of formation 142 on the lateral side of borehole 102 can be imaged azimuthally without being crossed by logging tool 300 along with the heterogeneities above and below the logging tool 300 (contrary to, for example, low relative azimuth angle α inversion, which can be used to image 2D features along the borehole trajectory). Consequently, non-uniform inversion grid 1300 can be symmetric with the same discretization vertically (along “z”-axis) and horizontally (along “y”-axis) because non-uniform inversion grid 1300 can initially be assumed to be perpendicular to a horizontal tool (such as logging tool 300).

In one possible implementation, setup of a 2D inversion domain discretization and regularization can be achieved using techniques similar to those used in 2D pixel curtain section inversion. For example, in one possible aspect, it can be assumed that logging tool 300 is nearly perpendicular to imaging plane 902. Moreover, the inversion can start with an azimuth angle α at or near 90° in accordance with the angle definitions of FIG. 10. Data associated with a plurality of positions of logging tool 300 along borehole trajectory 906 can then be processed.

In one possible embodiment, in some high relative azimuth scenarios (including, for example, scenarios in which azimuth angle α is more than 60 degrees), 2D formation discretization can use the same non-uniform pixel distribution in both directions as in the 1D inversion, as shown in FIG. 13. In one possible implementation, no adjustment of the pixel width with azimuth angle α is made, which may differ from some aspects of the techniques described in the Section (vi) above titled “2D Inversion for Low Relative Azimuth Starting From the Reference Trajectory Plane”. Further, as azimuth angle α of 90° is the starting point for this inversion, a complementary angle αₚ to azimuth angle α can be defined as αₚ=α−90° for positive azimuth and αₚ=α+90° for negative azimuth, setting the inversion starting point conveniently at αₚ=0°.

In one possible implementation, with regard to inversion and regularization, the inversion cost function can be the same as in curtain section inversion, with the axes of the 2D imaging plane (for example imaging plane 902) now being z and x instead of TVD and THL.

$$C ( x ) = \frac{1}{2} {\sum }_{k} {{w}_{k}^{2} ( {d}_{k}^{o b s} - {f}_{k} ( x ) )}^{2} + \frac{1}{2} {λ}_{x} {\sum }_{i} \sqrt{{( {w}_{x , i} \cdot ( {x}_{i} - {x}_{i - 1} ) )}^{2} + {c}^{2}} + \frac{1}{2} {λ}_{z} {\sum }_{i} \sqrt{{( {w}_{z , i} \cdot ( {x}_{i} - {x}_{i - N} ) )}^{2} + {c}^{2}}$$

$$C ( x ) = \frac{1}{2} {\sum }_{k} {{w}_{k}^{2} ( {d}_{k}^{o b s} {f}_{k} ( x ) )}^{2} + \frac{1}{2} {λ}_{x} {\sum }_{i} \sqrt{{w}_{x , i}^{2} {( {x}_{i} {x}_{i - 1} )}^{2} + {c}^{2}} + \frac{1}{2} {λ}_{z} {\sum }_{i} \sqrt{{{w}_{z , i}^{2} ( {x}_{i} {x}_{i - N} )}^{2} + {c}^{2}}$$

In one possible aspect, this inversion can differ from standard 1D inversion and 2D curtain section inversion in the choice of regularization constant (aka regularization coefficient) λ. For example, λ can be chosen to be the same in both directions, λ=λ_{z}=λₓ, and can be estimated using any adaptive regularization technique known in the art, including, for example, Occam's method.

In one possible aspect, the derivative with respect to the relative azimuth angle αₚ and the relative polar angle β can be computed using finite difference method, resulting in two additional forward modeling calls in the computation of the Jacobian matrix.

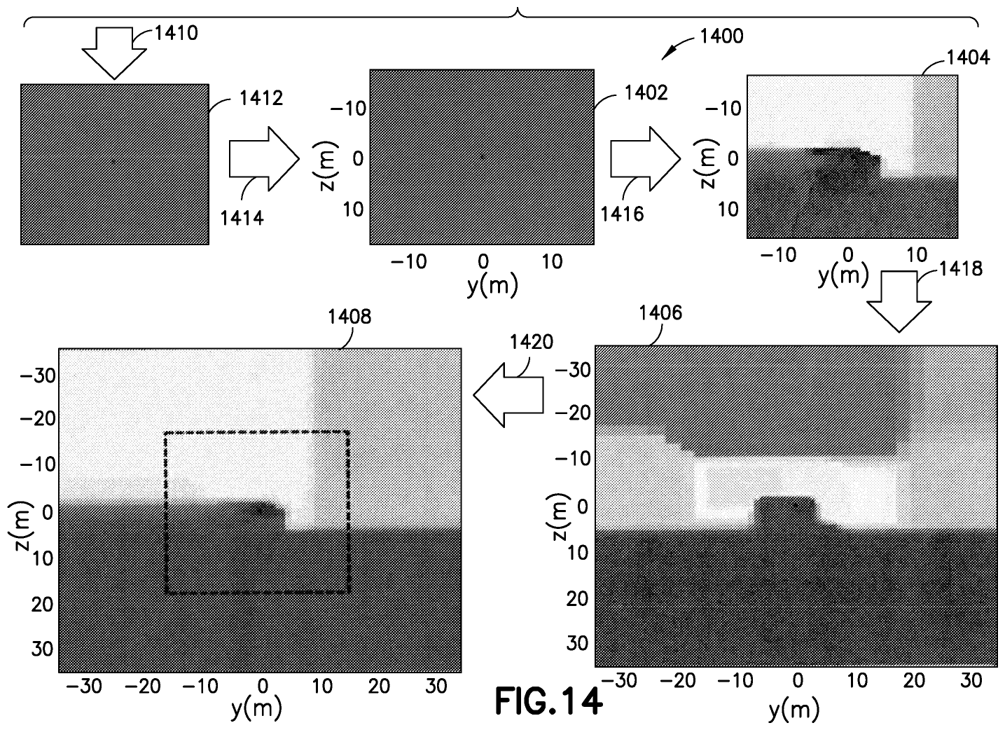

FIG. 14 illustrates an example flow diagram 1400 associated with a shallow to deep inversion workflow in accordance with various embodiments of the present disclosure. As illustrated, the reference point of the logging tool 300 is positioned at a center of the plots for the elements 1402, 1404, 1406, 1408 at y=z=0 m.

Similar to standard 1D inversion-based workflow, prior information is not used and flow diagram 1400 starts from raw conventional apparent resistivity data (“ARC”) from an array resistivity tool which are fed (arrow 1410) into the homogenous medium zero dimensional (0D) inversion 1412, used to produce one or more estimates 1412 of a background resistivity and resistivity anisotropy of formation 142 proximate to logging tool 300. In one possible implementation, the one or more 0D estimates 1412 can be produced by inverting for homogeneous medium resistivity and resistivity anisotropy of formation 142 proximate to logging tool 300. In one possible embodiment, each 0D estimate 1412 includes one resistivity and one resistivity anisotropy value associated with the background resistivity and resistivity anisotropy of formation 142 proximate to logging tool 300. The resistivity information processed at process 1410 can come from any resistivity tool known in the art, including for example, a nondirectional tool measuring resistivity approximately within one meter or less from logging tool 300.

In one possible implementation, when a nondirectional tool's measurements are used, the anisotropic resistivity calculated at process 1410, including potentially a desirable result 1414 (such as for example, a best 0D estimate 1412 of the one or more 0D estimates 1412 that exhibits a desirable and/or best fit to the measured data in accordance with the inversion performed at process 1410), can be used to populate a homogeneous 2D formation model initial approximation 1402, fora given relative polar angle β and relative azimuth angle αₚ. In one possible aspect, several initial approximations 1402 can be generated by varying the relative polar angle β and the relative azimuth angle αₚ.

For instance, in one possible implementation, the found resistivity and resistivity anisotropy values from a best 0D estimate 1412 with a given relative polar angle β and relative azimuth angle αₚ can used to populate grid 1300 (i.e. the single values for resistivity and resistivity anisotropy from the best 0D estimate 1412 can be used to populate the entire grid 1300).

In another possible implementation, if data from a nondirectional tool is not used, initial approximations 1402 can be produced by inversion of short spacing deep-directional resistivity (DDR) measurements, such as those measured using a directional resistivity tool.

In yet another possible implementation, initial approximations 1402 associated with formation 142 can be produced by joint inversion of all available data (including any combination of short spacing deep-directional resistivity (DDR) measurements and nondirectional resistivity measurements).

In one possible implementation, at process 1416 one or more inversion results 1404 based on multiple initial approximations 1402 can be produced with the same resistivity and resistivity anisotropy values in each initial approximation 1402 while varying relative polar angles β and relative azimuth angles αₚ, using any method known in the art (including, for example, inversion) and/or any mapping-while-drilling service known in the art, including, for example, a subset of the available deep-directional data of the GEOSPHERE mapping-while-drilling service of Schlumberger Technology Corporation.

For example, in one possible aspect, for each initial approximation 1402 the relative polar angle β and the relative azimuth angle αₚ can be sampled uniformly, with N polar angle samples from, for instance, −30° to +30°, and M relative azimuth angle αₚ samples from, for instance, −50° to +50°, leading to N*M realizations of a single initial approximation 1402, creating N*M initial approximations 1402, where N and M can be any numbers desired. In such a manner, multiple starting values of the relative polar angles β and the relative azimuth angles αₚ can thus be used to simultaneously estimate the resistivity and resistivity anisotropy, relative polar angles β and the relative azimuth angles αₚ in the one or more inversions (such as processes 1416), creating results 1404. In one possible embodiment, if it is found that the ARC inversion (1416) misfit is high, it may be inferred that logging tool 300 is close to a boundary of formation 142, and additional initial approximations 1402 with reduced resistivity may be desirable.

In one possible embodiment, at least some of the one or more inversion results 1404 can be post-processed (1418), using any method known in the art, including selecting a model with the best fit, model averaging, finding a residual weighted averaged result of at least some of the inversion results 1404, etc. The post-processing can be conducted on any value in the inversion results 1404, including resistivities (horizontal resistivity Rₕ and/or vertical resistivity Rᵥ), relative polar angles β and relative azimuth angles αₚ.

The post-processing 1418 can be used to populate a non-uniform grid, such as grid 1300, to create one or more initial approximations 1406 for the inversion (1420) which can be used to create a final inversion result 1408 using some or all of the available deep-directional data. Final inversion result 1408 can be created using any inversion technique known in the art and/or any deep directional resistivity data known in the art, including, for example, a subset or all available measurements of the GEOSPHERE mapping-while-drilling service marketed by the Schlumberger Technology Corporation of Houston, Tex.

In one possible implementation, the inversion domain can be extended to create one or more final inversion results 1408, by extending the model from the short spacing (R1) inversion results externally to cover a domain comparable to a measurement depth of investigation (i.e. a range of sensitivity). In such a case, the relative polar angles β and the relative azimuth angles αₚ can be inverted again along with the EM properties distributions using N*M initial approximations with two angle values uniformly sampled in the polar αₚ and azimuth angle β space, as discussed in conjunction with inverting for multiple inversion results 1404 above. In one possible aspect, the residual weighted averaged formation resistivities and resistivity anisotropies of all final inversion results 1408, and residual weighted average of the inverted relative polar angle β and relative azimuth angle αₚ can be used to create a final inversion result (which will be discussed in more detail in conjunction with FIG. 16 below).

As in 1D inversion-based workflows, a desirable and/or best model may also be useful, and formation variation for different regularization coefficients A can also be used as an indicator of uncertainty, such as described in PCT Application WO 2015/134455, which is herein incorporated in its entirety by reference.

In one possible implementation, both the inversion processes used to create multiple inversion results 1404 and the one or more final inversion results 1408 can include conventional resistivity (ARC) measurements.

In another possible implementation, the workflow in example flow diagram 1400 can start from a 1D inversion, and use 1D inversion result(s) as an initial approximation 1402, similar to that discussed above with regard to the Section (vi) titled “2D Inversion for Low Relative Azimuth Starting From the Reference Trajectory Plane”. In such a case, the initial 2D model could include a layered 1D formation rotated by the relative azimuth angle αₚ in the reference trajectory plane 904 perpendicular to THL.

In one possible implementation, all or part of the algorithm used to complete the 2D inversion used to determine final inversion results 1408 from initial approximations 1406 can be parallelized such that the response in each measurement point and for each frequency can be computed independently. In addition, if desired, a second parallelization level/layer can be added to the inversion by running inversions for some or all of initial approximations 1406 simultaneously. Any number and/or types of processors can be utilized to pursue such parallelization efforts, including, for example, in the order of 10,000 processors. In one possible aspect, 2.5D forward modeling to simulate directional resistivity tool responses at different frequencies for different receivers can be parallelized.

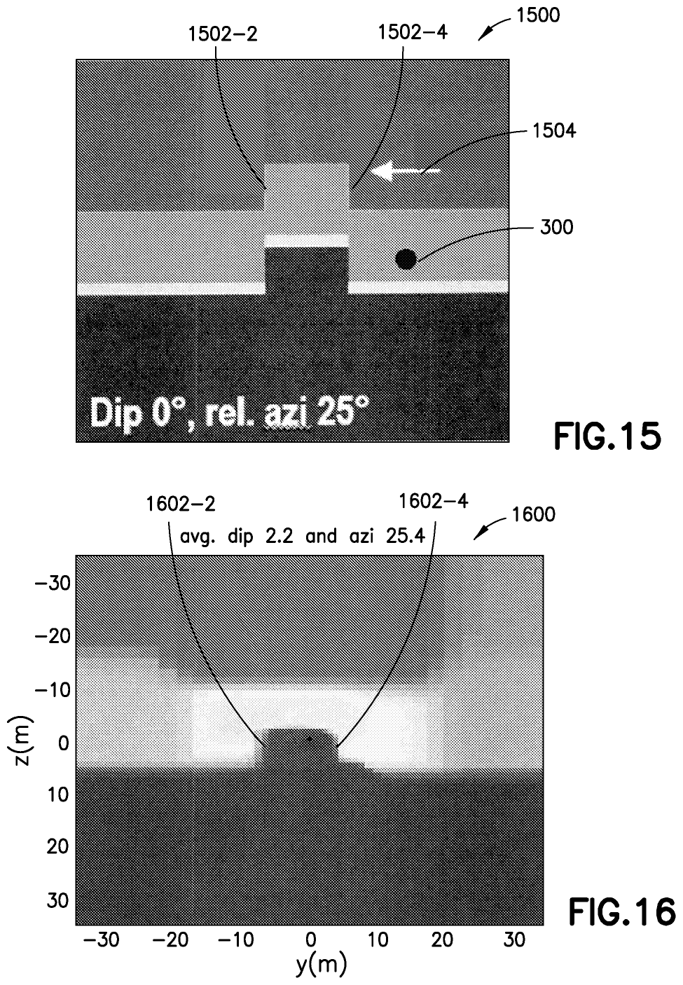

FIG. 15 illustrates an example two dimensional (2D) formation model 1500 in accordance with various embodiments of the present disclosure. As illustrated, logging tool 300 is crossing a double fault structure created by two faults 1502-2 and 1502-4 with a direction 1504 from right to left at a relative azimuth angle of αₚ=25° (and relative polar angle β of 0°). In one possible implementation, 1D inversion would not be able to fit measurements close to faults 1502. Consequently, a risk exists that 1D inversion might return a wrong resistivity profile along with an undesirable error and mismatch in an estimate 408 between the original responses and inversion reconstructed responses for two dimensional (2D) formation model 1500 near the faults 1502.

FIG. 16 illustrates an example final inversion derived model 1600 in accordance with various embodiments of the present disclosure. In one possible implementation, final inversion derived model 1600 is created from multiple final inversion results 1408. For example, in one possible implementation, final inversion 1600 can be created from multiple final inversion results 1408 in a manner similar to that discussed above used to a create post-processed averaged model (such as initial approximations 1406) from multiple inversion results 1404.

As illustrated, final inversion 1600 shows discontinuities 1602-2 and 1602-4 in the approximate location of faults 1502-2 and 1502-4. Final inversion 1600 was created using the workflow in flow diagram 1400, with a window of 11 data points, acquired every 0.5 m. Final inversion 1600 was obtained with 36 initial approximations for the 6 different relative polar angles β and 6 values of relative azimuth angle αₚ. The computed values of polar and relative azimuth angle αₚ are 2.2° and 25.4°, compared to the true values of 0° and 25°, respectively. It will be understood that in addition to the various data and specifications listed above, final inversion derived model 1600 can be created using any numbers of data points, spacings, initial approximations, etc., known in the art.

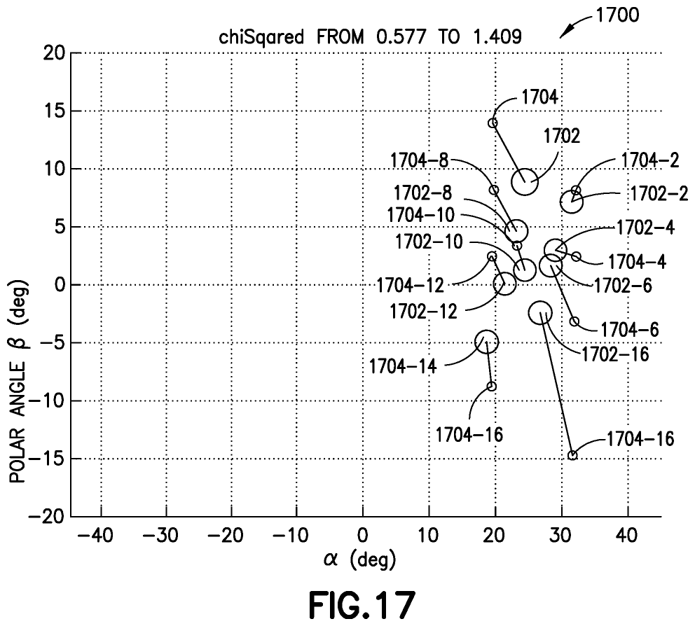

FIG. 17 illustrates an example scatter plot 1700 with points 1702 representing the inverted polar angle and inverted azimuth angles αₚ of acceptable solutions (e.g. solutions with error terms within a desirable range—such as, for example, less than 2.5 times the minimum residual of all solutions) in accordance with various embodiments of the present disclosure. In one possible aspect, points 1702 can represent acceptable inversion results 1404 and/or acceptable final inversion results 1408, and scatter plot 1700 can be used to estimate the uncertainty of the inverted polar angles β and inverted azimuth angles αₚ associated with the acceptable inversion results 1404 and/or acceptable final inversion results 1408. For example, by displaying inverted polar angles β and relative azimuth angles αₚ of acceptable solutions, the region where the true polar angle β and relative azimuth angle αₚ may be found can be illustrated as the area bounded by points 1702. The corresponding value of angle initial approximations are shown as open points 1704. In some possible implementations, acceptable solutions represented by points 1702 may be a small minority of actual solutions found. For example, in the case of fifty found solutions, it may not be uncommon to have nine or less acceptable solutions represented by points 1702 with error terms within a desirable range.

In one possible implementation, the found resistivity and resistivity anisotropy distribution in final inversion derived model 1600 can be used to reconstruct the true nature of formation 142 within the limits of what the measurements can resolve. For example, the synthetic responses of the inverted model represented by final inversion derived model 1600 and the original measurements of logging tool 300 can confirm the ability of final inversion 1600 to reconstruct the measurements of logging tool 300 within the assumed noise values.

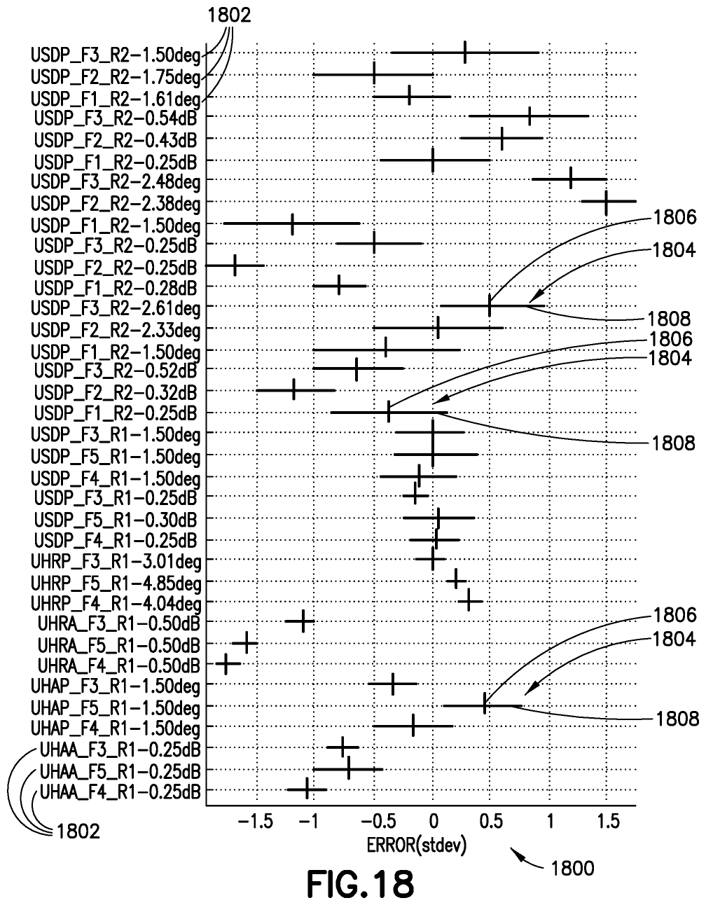

FIG. 18 includes a chart 1800 illustrating the mean values and standard deviations of found relative data reconstruction errors associated with individual measurement channels and measurement noise standard deviation 1802 in accordance with various embodiments of the present disclosure. Statistics 1804 associated with the relative data reconstruction error of each channel 1802 are plotted, with lines 1806 indicating the average (or mean) relative data reconstruction error for each measurement channel 1802 and lines 1808 indicating the standard deviation of the relative data reconstruction error in positive (+) and negative (−) directions from the average (or mean) indicated by line 1806, normalized to measurement noise standard deviation for each individual measurement. The relative data reconstruction error can be calculated in any manner known in the art, including manners discussed above in the Section (ii) entitled “Examples of 2D Inversion”)

In one possible implementation, chart 1800 can allow an operator or other concerned individual to review the reconstruction quality of the original responses of logging tool 300, since chart 1800 illustrates the statistics of the differences between the synthetic and original responses normalized to the corresponding response noise standard deviation of logging tool 300.

In one possible aspect, differences between the synthetic and original responses of logging tool 300 can be computed for some or all of the solutions that can satisfactorily explain (reconstruct) the data and are used in the final resistivity image (such as final inversion derived image 1600), which are weighted by the assumed noise standard deviation value in the inversion to form a relative error. In one possible aspect, the final inversion derived resistivity image is derived by residual weighted averaging of individual inversion solutions for each pixel, which can be computed from multiple solutions that can satisfactorily explain (reconstruct) the data (such as final inversion results 1408).

Returning to FIG. 16, in one possible implementation, a number of initial approximations 1406 can be used to estimate the uncertainty of resistivity (and resistivity anisotropy) of the solution in the form of final inversion result 1408. For example, in one possible aspect, nine individual solutions (aka final inversion results 1408) can be used to compute the final inversion 1600. The error weighted standard deviation from the mean resistivity can be computed for each pixel and visualized as the uncertainty. Because the inversion parameter can be log 10(resistivity), in one possible aspect, the uncertainty can be computed and plotted with log 10(resistivity) as well. The standard deviation of the relative polar angle β and the relative azimuth angle αₚ can also be computed this way and their correlations can be revealed in a scatter plot such as scatter plot 1700.

It will be understood that in addition to the various values given above, the examples described in FIGS. 16-18 can use any other values known in the art, including various window sizes, windows of various numbers of data points with various sampling rates, various numbers of initial approximations for the relative polar angle β and relative azimuth angle αₚ, etc.

In one possible implementation, 2D pixel inversions with a 3D trajectory created using aspects of the Sections (vi) and (vii) above titled “Example 2D Inversion for Low Relative Azimuth Starting From the Reference trajectory plane” and “2D Inversion With Relative Azimuth Starting From a Perpendicular Plane” may be applicable if formation 142 is locally invariant in one direction in the processed interval. If this condition is not met, the formation may be 3D, and the two 2D pixel inversions created using these methods might not be able to reconstruct the complete set of measurements from logging tool 300, resulting instead in high inversion residuals. Such behavior may act as a full 3D formation complexity indicator, suggesting that formation 142 adjacent to logging tool 300 is locally 3D.

### Example Workflows

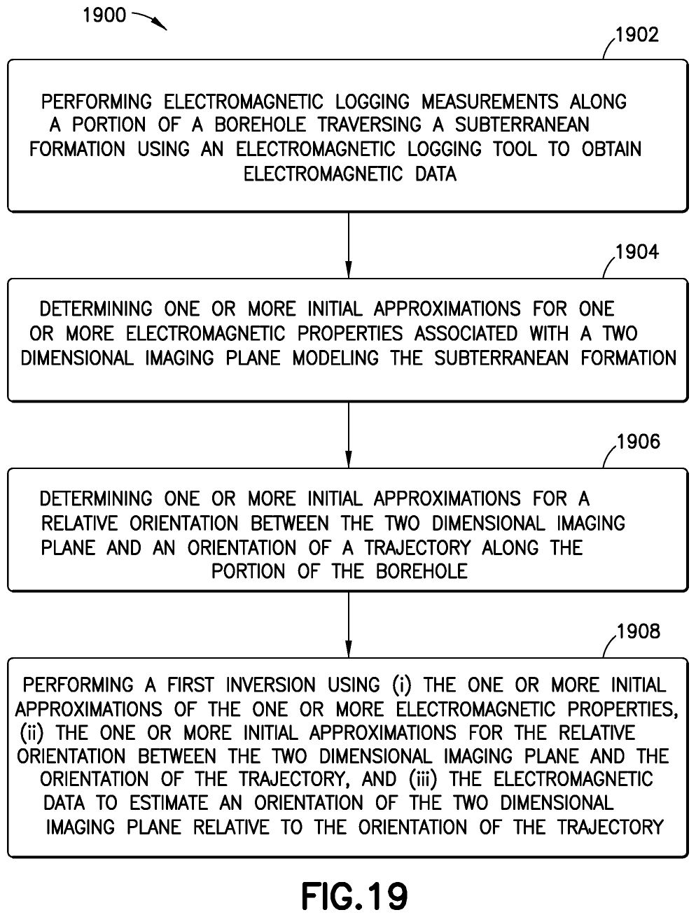

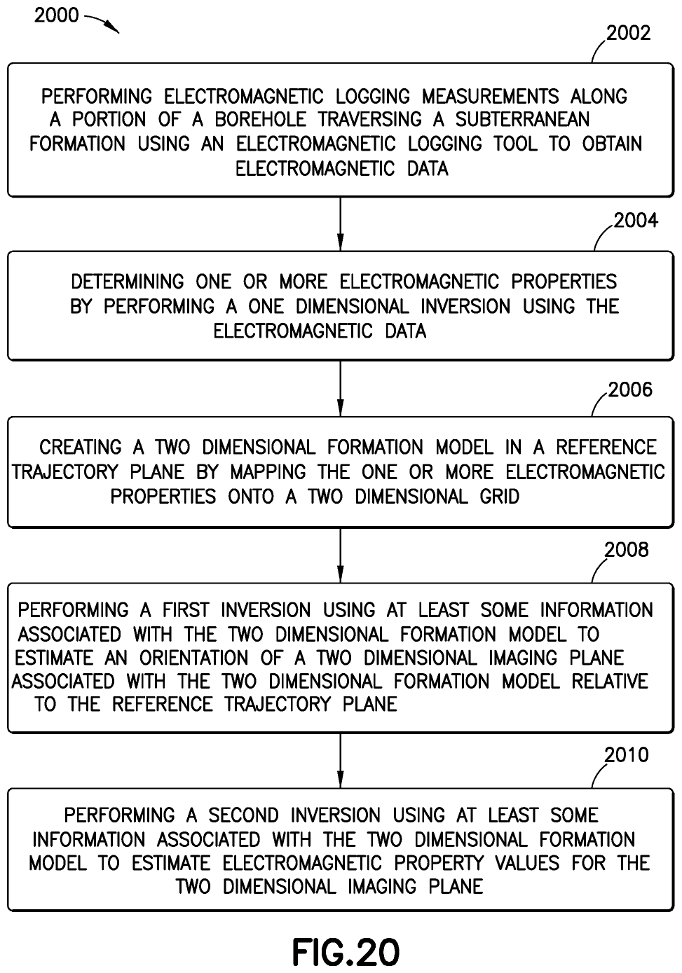

FIGS. 19 and 20 illustrate example methods for implementing aspects of the two dimensional inversion described herein. The methods are illustrated as a collection of blocks and other elements in a logical flow graph representing a sequence of operations that can be implemented in hardware, software, firmware, various logic or any combination thereof. The order in which the methods are described is not intended to be construed as a limitation, and any number of the described method blocks can be combined in any order to implement the methods, or alternate methods. Additionally, individual blocks and/or elements may be deleted from the methods without departing from the spirit and scope of the subject matter described therein. In the context of software, the blocks and other elements can represent computer instructions that, when executed by one or more processors, perform the recited operations. Moreover, for discussion purposes, and not purposes of limitation, selected aspects of the methods may be described with reference to elements shown in FIGS. 1-18. Moreover, in some possible implementation, all or portions of the methods may, at least partially, be conducted using, for example, processing system 200.

FIG. 19 illustrates an example method 1900 for characterizing a subterranean formation (e.g., 142).

At block 1902, the method includes performing electromagnetic logging measurements along a portion of a borehole (e.g., 102) traversing the subterranean formation (e.g., 142) using an electromagnetic logging tool (e.g., 300) to obtain electromagnetic data.

At block 1904, the method includes determining one or more initial approximations for one or more electromagnetic properties associated with a two dimensional imaging plane (e.g., 902) modeling the subterranean formation. In some embodiments, the one or more initial approximations for the one or more electromagnetic properties are determined by performing a one dimensional inversion that uses the electromagnetic data (e.g., to determine a 1D formation model (e.g. 408) associated with the formation). In some embodiments, the one or more initial approximations for one or more electromagnetic properties are determined from randomly generating the one or more electromagnetic properties.

At block 1906, the method includes determining one or more initial approximations for a relative orientation between the two dimensional imaging plane and an orientation of a trajectory along the portion of the borehole. In some embodiments, the one or more initial approximations for the relative orientation between the two dimensional imaging plane and the orientation of the trajectory along the portion of the borehole are determined by assuming that the two dimensional imaging plane is perpendicular to the orientation of the portion of the borehole. In some embodiments, the one or more initial approximations for the relative orientation between the two dimensional imaging plane and the orientation of the trajectory along the portion of the borehole are determined from one or more one dimensional inversion derived models (such as, for example, 1D formation models 408) and/or one or more two dimensional inversion derived models (such as, for example, 2D formation models 600 and/or curtain section models 606) associated with the formation.

At block 1908, the method includes performing a first inversion using (i) the one or more initial approximations of the one or more electromagnetic properties, (ii) the one or more initial approximations for the relative orientation between the two dimensional imaging plane and the orientation of the trajectory, and (iii) the electromagnetic data to estimate an orientation of the two dimensional imaging plane relative to the orientation of the trajectory.

FIG. 20 illustrates another example method 2000 for characterizing a subterranean formation (e.g., 142).

At block 2002, the method includes performing electromagnetic logging measurements along a portion of a borehole (e.g., 102) traversing the subterranean formation (e.g., 142) using an electromagnetic logging tool (e.g., 300) to obtain electromagnetic data.

At block 2004, the method includes determining one or more electromagnetic properties by performing a one dimensional inversion using the electromagnetic data.

At block 2006, the method includes creating a two dimensional formation model in a reference trajectory plane by mapping the one or more electromagnetic properties onto a two dimensional grid

At block 2008, the method includes performing a first inversion using at least some information associated with the two dimensional formation model to estimate an orientation of a two dimensional imaging plane (e.g., 902) associated with the two dimensional formation model relative to the reference trajectory plane. In one possible implementation, the first inversion can be performed to estimate the orientation of the two dimensional imaging plane relative to the reference trajectory plane in terms of an azimuth angle α and/or a polar angle β.

At block 2010, the method includes performing a second inversion using at least some information associated with the two dimensional formation model to estimate electromagnetic property values for the two dimensional imaging plane. In one possible implementation, electromagnetic property values can include one or more of: resistivity properties, resistivity anisotropy properties, conductivity properties, conductivity anisotropy properties, dielectric permittivity properties, and dielectric permittivity anisotropy properties.

Furthermore, in some embodiments, the first inversion and the second inversion are performed together in a single process. In some embodiments, the first inversion and the second inversion are performed sequentially.

Although a few example embodiments have been described in detail above, those skilled in the art will readily appreciate that many modifications are possible in the example embodiments without materially departing from this disclosure. Accordingly, such modifications are intended to be included within the scope of this disclosure.

1. A method for characterizing a subterranean formation, the method comprising:
performing electromagnetic logging measurements along a portion of a borehole traversing the subterranean formation using an electromagnetic logging tool to obtain electromagnetic data;
determining one or more initial approximations for one or more electromagnetic properties associated with a two dimensional imaging plane modeling the subterranean formation;
determining one or more initial approximations for a relative orientation between the two dimensional imaging plane and an orientation of a trajectory along the portion of the borehole; and
performing a first inversion using (i) the one or more initial approximations of the one or more electromagnetic properties, (ii) the one or more initial approximations for the relative orientation between the two dimensional imaging plane and the orientation of the trajectory, and (iii) the electromagnetic data to estimate an orientation of the two dimensional imaging plane relative to the orientation of the trajectory.

2. The method of claim 1, further comprising:
performing a second inversion to estimate one or more electromagnetic property values associated with the two dimensional imaging plane using the electromagnetic data.

3. The method of claim 2, further comprising:
performing the first inversion and the second inversion together in a single process.

4. The method of claim 2, wherein the electromagnetic logging tool is part of a drilling bottom-hole assembly with a drill bit and the method further comprises:
issuing one or more commands to steer the drill bit based at least partially on one or more of:
the orientation of the two dimensional imaging plane relative to the orientation estimated in the first inversion;
the one or more electromagnetic property values associated with the two dimensional imaging plane estimated in the second inversion.

5. The method of claim 2, wherein at least one of the first inversion and the second inversion is a Gauss-Newton regularized inversion that comprises at least one of Occam's adaptive regularization method; a L-curve technique; and a generalized cross-validation.

6. The method of claim 1, wherein the one or more initial approximations for the one or more electromagnetic properties are determined by performing a one dimensional inversion that uses the electromagnetic data.

7. The method of claim 1, wherein the one or more initial approximations for the relative orientation between the two dimensional imaging plane and the orientation of the trajectory along the borehole are determined from one or more of:
one or more one dimensional inversion derived models associated with the formation; and
one or more two dimensional inversion derived models associated with the formation.

8. The method claim 2, wherein the one or more electromagnetic property values comprise at least one of:
resistivity properties;
resistivity anisotropy properties;
conductivity properties;
conductivity anisotropy properties;
dielectric permittivity properties; and
dielectric permittivity anisotropy properties.

9. A method for characterizing a subterranean formation, the method comprising:
performing electromagnetic logging measurements along a portion of a borehole traversing the subterranean formation using an electromagnetic logging tool to obtain electromagnetic data;
determining one or more electromagnetic properties by performing a one dimensional inversion using the electromagnetic data;
creating a two dimensional formation model in a reference trajectory plane by mapping the one or more electromagnetic properties onto a two dimensional grid;
performing a first inversion using at least some information associated with the two dimensional formation model to estimate an orientation of a two dimensional imaging plane associated with the two dimensional formation model relative to the reference trajectory plane; and
performing a second inversion using at least some information associated with the two dimensional formation model to estimate electromagnetic property values for the two dimensional imaging plane.

10. The method of claim 9, wherein the first inversion and the second inversion are performed sequentially.

11. The method claim 9, wherein the orientation of the two dimensional imaging plane to the reference trajectory plane is defined in terms of at least one of an azimuth angle α and a polar angle β.

12. The method claim 11, wherein the first inversion is performed with a relative polar angle β initially set to zero.

13. The method of claim 9, wherein the one or more electromagnetic property values comprise at least one of:
resistivity properties;
resistivity anisotropy properties;
conductivity properties;
conductivity anisotropy properties;
dielectric permittivity properties; and
dielectric permittivity anisotropy properties.

14. The method of claim 9, wherein the electromagnetic logging tool is part of a drilling bottom-hole assembly with a drill bit and the method further comprises:
issuing one or more commands to steer the drill bit based at least partially on one or more of:
the orientation of the two dimensional imaging plane relative to the relative to the reference trajectory plane; and
the one or more electromagnetic property values associated with the two dimensional imaging plane estimated in the second inversion.

15. A system for characterizing a subterranean formation, the system comprising:
an electromagnetic logging tool configured to perform electromagnetic logging measurements along a portion of a borehole traversing the subterranean formation to obtain electromagnetic data; and
a processing system configured to:
(i) determine one or more initial approximations for one or more electromagnetic properties associated with a two dimensional imaging plane modeling the subterranean formation;
(ii) determine one or more initial approximations for a relative orientation between the two dimensional imaging plane and an orientation of a trajectory along the portion of the borehole; and
(iii) perform a first inversion using (a) the one or more initial approximations of the one or more electromagnetic properties, (b) the one or more initial approximations for the relative orientation between the two dimensional imaging plane and the orientation of the trajectory, and (c) the electromagnetic data to estimate an orientation of the two dimensional imaging plane relative to the orientation of the trajectory.

16. The system of claim 15, wherein the processing system is further configured to perform a second inversion to estimate one or more electromagnetic property values associated with the two dimensional imaging plane using the electromagnetic data.

17. The system of claim 16, further comprising:
a drilling bottom-hole assembly that includes a drill bit

18. The system of claim 17, wherein the processing system is further configured to steer the drill bit using at least one of (i) the orientation of the two dimensional imaging plane relative to the orientation estimated in the first inversion and (ii) the one or more electromagnetic property values associated with the two dimensional imaging plane estimated in the second inversion.

19. The system of claim 16, wherein the one or more initial approximations for one or more electromagnetic properties are determined from randomly generating the one or more electromagnetic properties.

20. The system of claim 15, wherein the one or more initial approximations for the relative orientation between the two dimensional imaging plane and the orientation of the trajectory along the portion of the borehole are determined by assuming that the two dimensional imaging plane is perpendicular to the orientation of the portion of the borehole.
